(19) United States
(12) Patent Application Publication
(10) Pub. No.: US 2024/0378055 A1
(43) Pub. Date: Nov. 14, 2024

(54) METHODS AND SYSTEM FOR IMPROVED PROCESSING OF SEQUENTIAL DATA IN A NEURAL NETWORK

(71) Applicant: BrainChip, Inc., Laguna Hills, CA (US)

(72) Inventors: Olivier Jean-Marie Dominique COENEN, Encinitas, CA (US); Yan Ru PEI, Irvine, CA (US)

(73) Assignee: BrainChip, Inc., Laguna Hills, CA (US)

(21) Appl. No.: 18/660,015

(22) Filed: May 9, 2024

Related U.S. Application Data
(60) Provisional application No. 63/466,057, filed on May 12, 2023.

(51) Int. Cl. G06F 9/30

(52) U.S. Cl. CPC G06F 9/3004; G06F 9/30069

(57) ABSTRACT

Disclosed is a system that includes a processor configured to process data in a neural network and a memory associated with a primary flow path and at least one secondary flow path within the neural network. The primary flow path comprises one or more primary operators to process the data and the at least one secondary flow path is configured to pass the data to a combining operator by skipping the processing of the data over the primary flow path. The processor is configured to provide the primary flow path and the at least one secondary flow path with a primary sequence of data and a secondary sequence of data respectively such that the secondary sequence of data being time offset from the processed primary sequence of data.

### TECHNICAL FIELD

The present application relates generally to neural networks, and more particularly but not exclusively, to systems and methods for implementing neural networks with skip connections.

### BACKGROUND

Convolutional neural networks (CNNs) are generally used for various tasks, such as segmentation and classification. Skip connections may be implemented within the CNNs in order to solve problems, such as overfitting and vanishing gradients and improve performance of the CNNs. Skip connections neural networks (skipNN) generally involve providing a pathway for some neural responses to bypass one or more convolution layers within the skipNN.

Parallel pathways may be created for the neurons' response to pass through the convolution layers in one pathway to generate processed features. The neurons' response may also be made to skip the convolution layers in a parallel pathway to thereby remain relatively unprocessed. The processed features correspond to the downstream features, i.e., downstream of the convolution layers while the unprocessed neurons' responses correspond to the upstream features, i.e., upstream of the convolution layers. The parallel pathways may then be combined, in that, the upstream features routed directly are summed with the downstream features.

Synchronization of skip connections with the flow of features through skipNNs is conventionally implemented, in that, upstream features from one frame, say frame n (corresponding to Data N as illustrated in FIG. 1, where n may be any integer, n in FIG. 1 may have potential values 1, 2, . . . , N, N+1, N+2, . . . , infinity), is made to sum with downstream features from the same frame n′ (corresponding to Data N′ as illustrated in FIG. 1). FIG. 1 illustrates a synchronous skipNN in communication with a memory, which may be a buffer memory implemented on hardware in the cloud or at the edge. In order to achieve synchronization, the memory may be implemented to receive upstream features and delay the arrival of upstream features at the summation point. This ensures that features corresponding to the same frame n arrive at the summation point in synchronization (with no time offset). As seen in FIG. 1, a main path 102 and a skip path 104 is provided from a branching point 106. A buffer 1 may be provided at the skip path 104 while a plurality of layers 110 may be provided at the main path 102, such as, layer 1, layer 2, . . . layer N. The plurality of layers 110 may be configured to process the data in order to generate processed data. At a merging point 112, data 1 merges with processed data 1′ and subsequently, data 2 will merge with processed data 2′, and so on. The merged output may then be stored in a buffer, such as, buffer 2.

One of the known art (Tailoring Skip Connections for More Efficient ResNet Hardware—https://kastner.ucsd.edu/tailoring-skip-connections-for-more-efficient-resnet-hardwaree/) identifies the issue associated with skip connection. It mentions that the skip connection requires additional on-chip memory and other resources and larger memory bandwidths, therefore suggests removing longer skip connection paths and implementing shorter connection paths. This indicates that skip connections require more memory availability to implement. This is particularly the case since additional memory is required to support implementation of synchronization at some point along the skip connection path.

Another known art (Altering Skip Connections for Resource-Efficient Inference-https://dl.acm.org/doi/10.1145/3624990) discloses “Deep neural networks use skip connections to improve training convergence. However, these skip connections are costly in hardware, requiring extra buffers and increasing on- and off-chip memory utilization and bandwidth requirements.”. This indicates that there is an existing problem of higher memory requirement when skip connections are implemented in neural networks.

Other established neural network models like ResNet, ImageNet, MobileNet, U-Net, and ConvLSTM also implement skip connection with synchronization.

Synchronization as described above, such as in FIG. 1, may be difficult to achieve particularly in scenarios where a large network of convolution layers, and multiple skip connections, are provided. For instance, a network of 100 or more layers may be provided with multiple skip connections with varying complexity rendering synchronization of parallel pathways a complicated and memory hungry task. Although synchronization of parallel pathways is being implemented in skip connection networks, there arises a need to increase the performance and accuracy of such neural networks.

Currently, there exists no skip neural network implementation by which an increased performance of network is achieved without synchronizing the parallel pathways. Accordingly, one of the advantages of the present disclosure is memory efficient skipNN implementation, by configuring processing of data over two or multiple paths without synchronization (keeping a time offset). Low requirement of memory when implementing some skipNN with no or smaller memory buffer may in addition facilitate the implementation of applications at the edge.

Currently, there exists no neural network implementation by which an increased performance of network is achieved by delaying certain or all of parallel pathways relative to each other. Accordingly, one of the advantages of the present disclosure is providing different amount of delays along parallel pathways in skipNN implementation, by configuring processing of data over two or multiple paths with time offset, thus with no synchronization with the goal to increase the performance of the network.

Therefore. it would be advantageous to implement a skip neural network that solves each of the above discussed problems and one or more combinations of the above discussed problems.

### SUMMARY

This summary is provided to introduce a selection of concepts in a simplified form that is further described below in the Detailed Description section. This summary is not intended to identify or exclude key features or essential features of the claimed subject matter, nor is it intended to be used as an aid in determining the scope of the claimed subject matter.

The present disclosure provides methods and systems for implementation of memory efficient neural networks with skip connections and effective dynamical system embedding in neural networks, in particular, for networks that process continuous input data. Continuous input data may refer to sequential data or streaming data such as a data comprising a series of frames. The term “sequential data”, “streaming data” and “continuous data” may be used interchangeably in the present disclosure. The series of frames may be presented as continuous video, audio, time series, and the like. In neural networks with skip connections processing sequential data, the synchronization of parallel pathways is not essential, and one or multiple time offset(s) (delay(s)) may be added among the parallel pathways to improve performance. Further, the delay(s) may be adjusted with a certain range.

Further, as described above, in order to achieve synchronization, a memory may be utilized at skip connections. However, in case of a complex network with multiple branched or nested skip connections, it may not always be possible to determine accurately how much memory would be sufficient for proper synchronous implementations. A shortfall in memory size would defeat the purpose of synchronization as the functionality of such a neural network may not be supported by the memory. As an example, a buffer memory may be utilized on a hardware chip that implements a neural network with a large number of layers and skip connections. The size of the buffer memory is a constraint on the implementation of large and complex neural networks with synchronized skip connections. Moreover, users may not be able to implement desired neural networks on the chip because of the size constraints.

Absence of utilization of memory for synchronization would eliminate the need for any additional synchronization management and simplify the implementation of the neural network. Considering an exemplary case of hardware chip implementing a complex neural network with skip connections, the elimination of memory utilization leads to less power consumption of the hardware as synchronization operations are eliminated. Furthermore, in case increasing a delay in processing of the parallel pathways is desired, a memory may be utilized in the convolution layer pathway or the skip pathway specifically in order to introduce and/or increase the delay.

According to an embodiment of the present disclosure, disclosed herein is a system comprising a processor configured to process data in a neural network and a memory comprising a plurality of memory elements associated with a primary flow path and at least one secondary flow path within the neural network. The data comprises a main sequence of data. The primary flow path comprises one or more primary operators to process the data. The at least one secondary flow path is configured to pass the data to a combining operator within the neural network by skipping the processing of the data over the primary flow path. The processor is configured to provide, from the memory, the primary flow path with a primary sequence of data from the main sequence of data. The processor is further configured to provide, from the one or more primary operators, a processed primary sequence of data based on processing of the primary sequence of data. The processor is further configured to provide, from the memory, the at least one secondary flow path with a secondary sequence of data from the main sequence of data, the secondary sequence of data being time offset from the processed primary sequence of data. The processor is further configured to receive, at the combining operator, the processed primary sequence of data from the primary flow path and the secondary sequence of data from the at least one secondary flow path. The processor is further configured to generate, at the combining operator, output data based on the processing of at least one sequence of data from the processed primary sequence of data and at least one sequence of data from the secondary sequence of data.

According to an embodiment of the present disclosure, the at least one secondary flow path comprises two or more secondary flow paths. The processor may be further configured to provide, from the memory, the two or more secondary flow paths each having a respective secondary sequence of data, each one of the respective secondary sequence of data being time offset from each other by a respective time offset value.

According to an embodiment of the present disclosure, the processor is further configured to provide a first one of the two or more secondary flow paths from a memory element of the plurality of memory elements. The processor is further configured to provide a second one of the two or more secondary flow paths from a different memory element of the plurality of memory elements.

According to yet another embodiment of the present disclosure, also disclosed herein is a method for processing data in a neural network. The data comprises a main sequence of data. The method being performed by a system comprising a processor and a memory having a plurality of memory elements associated with a primary flow path and at least one secondary flow path within the neural network. The method comprises providing, from the memory, the primary flow path with a primary sequence of data from the main sequence of data, wherein the primary flow path comprises one or more primary operators to process the data. The method further comprises providing, from the one or more primary operators, a processed primary sequence of data based on processing of the primary sequence of data. The method further comprises providing, from the memory, the at least one secondary flow path with a secondary sequence of data from the main sequence of data. The secondary sequence of data is time offset from the processed primary sequence of data. The at least one secondary flow path is configured to pass the data to a combining operator within the neural network by skipping the processing of the data over the primary flow path. The method further comprises receiving, at the combining operator, the processed primary sequence of data from the primary flow path and the secondary sequence of data from the at least one secondary flow path. The method further comprises generating, at the combining operator, output data based on the processing of at least one sequence of data from the processed primary sequence of data and at least one sequence of data from the secondary sequence of data.

According to yet another embodiment of the present disclosure, also disclosed herein is a system comprising a processor configured to process data in a neural network and a memory comprising a plurality of memory elements associated with a primary flow path and at least one secondary flow path within the neural network. The data comprises a main sequence of data. The primary flow path comprises one or more primary operators to process the data. The at least one secondary flow path comprises one or more secondary operators to process the data. The processor is configured to provide, from the memory, the primary flow path with a primary sequence of data from the main sequence of data. The processor is further configured to provide, from the memory, the at least one secondary flow path with a secondary sequence of data from the main sequence of data. The processor is further configured to provide, from the one or more primary operators, a processed primary sequence of data based on processing of the primary sequence of data. The processor is further configured to provide, from the one or more secondary operators, a processed secondary sequence of data based on processing of the secondary sequence of data. The processed secondary sequence of data is time offset from the processed primary sequence of data. The processor is further configured to receive, at a combining operator within the neural network, the processed primary sequence of the data from the primary flow path and the processed secondary sequence of data from the at least one secondary flow path. The processor is further configured to generate, at the combining operator, output data based on the processing of at least one sequence of data from the processed primary sequence of data and at least one sequence of data from the processed secondary sequence of data.

According to an embodiment of the present disclosure, the system includes an additional memory associated with the primary flow path and the at least one secondary flow path within the neural network. Further, to provide the processed primary sequence of data and the processed secondary sequence of data, the processor is configured to provide from the one or more primary operators, the processed primary sequence of data by processing the primary sequence of data stored in the memory and corresponding additional values stored in the additional memory. The processor is further configured to provide from the one or more secondary operators, the processed secondary sequence of data by processing the secondary sequence of data stored in the memory and the corresponding additional values stored in the additional memory.

According to an embodiment of the present disclosure, each of the one or more primary operators and the one or more secondary operators comprises a multiplication operator. Further, the corresponding additional values stored in the additional memory comprises corresponding kernel values. Further, the combining operator is a summation operator. The processor is further configured to receive, at the summation operator, the processed primary sequence of data and the processed secondary sequence of data from the respective multiplication operators. The processor is further configured to generate, at the summation operator, a temporally convoluted output data based on the processing of the processed primary sequence of data and the processed secondary sequence of data.

According to yet another embodiment of the present disclosure, also disclosed herein is a method for processing data in a neural network. The data comprises a main sequence of data. The method being performed by a system comprising a processor and a memory having a plurality of memory elements associated with a primary flow path and at least one secondary flow path within the neural network. The method comprises providing, from the memory, the primary flow path with a primary sequence of data from the main sequence of data. The primary flow path comprises one or more primary operators to process the data. The method further comprises providing, from the memory, the at least one secondary flow path with a secondary sequence of data from the main sequence of data. The at least one secondary flow path comprises one or more secondary operators to process the data. The method further comprises providing, from the one or more primary operators, a processed primary sequence of data based on processing of the primary sequence of data. The method further comprises providing, from the one or more secondary operators, a processed secondary sequence of data based on processing of the secondary sequence of data. The processed secondary sequence of data is time offset from the processed primary sequence of data. The method further comprises receiving, at a combining operator within the neural network, the processed primary sequence of the data from the primary flow path and the processed secondary sequence of data from the at least one secondary flow path. The method further comprises generating, at the combining operator, output data based on the processing of at least one sequence of data from the processed primary sequence of data and at least one sequence of data from the processed secondary sequence of data.

### BRIEF DESCRIPTION OF DRAWINGS

Non-limiting and non-exhaustive embodiments of the invention are described with reference to the following figures, wherein reference numerals refer to like parts throughout the various views unless otherwise specified.

FIG. 1 illustrates an example of a synchronized skip connection in a neural network, in accordance with existing art;

FIG. 2 illustrates a system configured to implement a neural network, in accordance with an embodiment of the disclosure;

FIGS. 3A-3D illustrates schematically various configurations of a memory for implementing in a neural network, in accordance with an embodiment of the disclosure;

FIGS. 4A-4E illustrate schematically various operator-memory configurations, in accordance with embodiments of the disclosure;

FIGS. 5A-5D illustrate various exemplary representations of a flow of a sequence of data in an operator-memory configuration within a neural network, in accordance with embodiments of the disclosure;

FIGS. 6A-6B illustrate various exemplary representations of a flow of a sequence of data in another operator-memory configuration within a neural network, in accordance with embodiments of the disclosure;

FIGS. 7A-7B illustrate various exemplary representations of a flow of a sequence of data in yet another operator-memory configuration within a neural network, in accordance with embodiments of the disclosure;

FIGS. 8A-8C illustrate various exemplary representations of a flow of a sequence of data in yet another operator-memory configuration within a neural network, in accordance with embodiments of the disclosure;

FIGS. 9A-9B illustrate various exemplary representations of a flow of a sequence of data in yet another operator-memory configuration within a neural network, in accordance with embodiments of the disclosure;

FIGS. 10A-10B illustrate various exemplary representations of a flow of a sequence of data in yet another operator-memory configuration within a neural network, in accordance with embodiments of the disclosure;

FIG. 11 illustrate an exemplary representation of a flow of a sequence of data in yet another operator-memory configuration within a neural network, in accordance with embodiments of the disclosure;

FIG. 12A-12B illustrate various exemplary representations of a flow of a sequence of data in yet another operator-memory configuration within a neural network, in accordance with embodiments of the disclosure;

FIG. 13 illustrates a flow chart of a method for processing data in a neural network, in accordance with another embodiment of the present disclosure;

FIG. 14 illustrates a flow chart of a method for processing data in a neural network, in accordance with another embodiment of the present disclosure; and

FIG. 15(i) and FIG. 15(ii) showcase bar graphs illustrating improved accuracy results attained through the implementation of the invention.

The features and advantages of the present invention will become more apparent from the detailed description set forth below when taken in conjunction with the drawings, in which similar reference numbers identify corresponding elements throughout. In the drawings, similar reference numbers generally indicate identical, functionally similar, and/or structurally similar elements. The drawing in which an element first appears is indicated by the leftmost digit(s) in the corresponding reference number.

### DETAILED DESCRIPTION

Various embodiments are described more fully below with reference to the accompanying drawings, which form a part hereof, and which show specific embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques, and implementations of the present disclosure to those skilled in the art. Embodiments may be practiced as methods, systems, or devices. Accordingly, embodiments may take the form of a hardware implementation, an entire software implementation, or an implementation combining software and hardware aspects. The following detailed description is, therefore, not to be taken in a limiting sense.

Reference in the specification to “one embodiment”, “an embodiment”, “another embodiment”, or “some embodiment” means that a particular feature, structure, or characteristic described in connection with the embodiments is included in at least one example implementation or technique in accordance with the present disclosure. The appearances of the phrase “in an embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Embodiments of the present invention may be implemented in hardware, firmware, software, or any combination thereof. Embodiments of the present invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical, or other forms of propagated signals (e.g., carrier waves, infrared signals, digital signals, etc.), and others. Further, firmware, software, routines, and instructions may be described herein as performing certain actions. However, it should be appreciated that such descriptions are merely for convenience and that such actions result from computing devices, processors, controllers, or other devices executing the firmware, software, routines, instructions, etc.

The input data to the network is preferably sequential, streaming or continuous data, that is generated by one or multiple sources that persists to exist for some time period. In some embodiments, the data is non-event or non-spiking data, and neural network is artificial neural network (ANN). It is known that input propagation in artificial neural networks (ANN) is significantly different from spiking neural networks (SNN) that takes spikes or events as input.

In some embodiments, the network through its multiple memory buffers and time-offset pathways, may provide an array of past values of pathway data that is beneficial for providing a richness of representation to model the dynamical system of the source or sources that may have generated the input data.

In some embodiments, a dynamical system can also be used which determines delays or time offsets of different values within a network and identify which delay(s) or time offset(s) is/are beneficial or can facilitate achieving higher accuracy results on particular delays or time offsets values.

The synchronization used in typical networks with skip connections is a priori neither necessary, nor beneficial for processing sequential data. In many instances, performance may improve, depending on data, if no synchronization is performed and if delay(s) or time offset(s) are introduced one way or another across different paths in a network. Our results do demonstrate that optimal values of delays, or time offsets, in different pathways in a network may be found to optimize performance according to network performance criteria.

Another aspect of the disclosure is that any connection may be endowed with a memory storage, which may be a source of one or multiple delays, or time offsets, and may be equipped as well with one or more operators to process in whole or in part the sequential data going through the connection. Thus, the purpose, goal, usage and implementation of skip connections are different, unique and novel compared to previous state of the art.

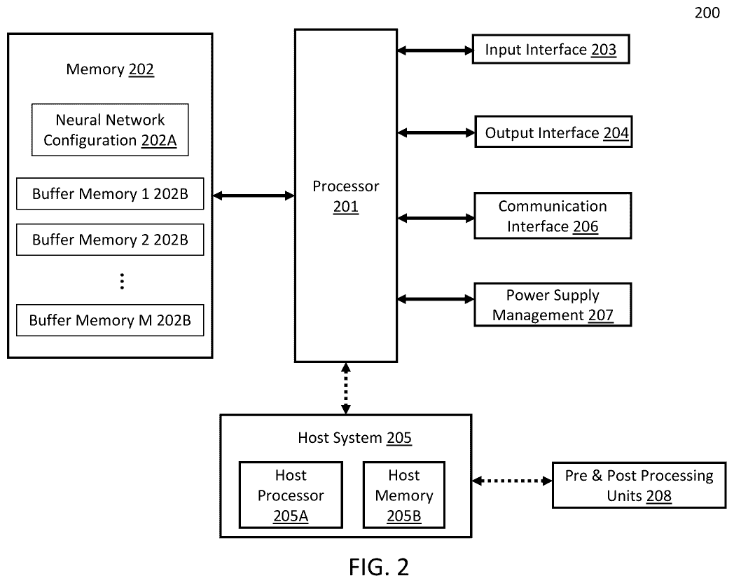

FIG. 2 illustrates an exemplary system diagram of an apparatus configured to implement a neural network, in accordance with an embodiment of the disclosure. FIG. 2 depicts a system 200 to implement the neural network. The system 200 includes a processor 201, a memory 202, an input interface 203, an output interface 204, a host system 205, a communication interface 206, a power supply management unit 207, and pre & post processing units 208.

In some embodiments, the processor 201 may be a single processing unit or several units, all of which could include multiple computing units. The processor 201 is configured to fetch and execute computer-readable instructions and data stored in the memory 202. The processor 201 may receive computer-readable program instructions from the memory 202 and execute these instructions, thereby performing one or more processes defined by the system 200. The processor 201 may include any processing hardware, software, or combination of hardware and software utilized by a computing device that carries out the computer-readable program instructions by performing arithmetical, logical, and/or input/output operations. Examples of the processor 201 include but not limited to an arithmetic logic unit, which performs arithmetic and logical operations, a control unit, which extracts, decodes, and executes instructions from the memory 202, and an array unit, which utilizes multiple parallel computing elements.

The memory 202 may include a tangible device that retains and stores computer-readable program instructions, as provided by the system 200, for use by the processor 201. The memory 202 can include computer system readable media in the form of volatile memory, such as random-access memory, cache memory, and/or a storage system. The memory 202 may be, for example, dynamic random-access memory (DRAM), a phase change memory (PCM), or a combination of the DRAM and PCM. The memory 202 may also include any non-transitory computer-readable medium known in the art including, for example, volatile memory, such as static random-access memory (SRAM), and/or non-volatile memory, such as read-only memory (ROM), erasable programmable ROM, flash memories, etc.

In some embodiments, the memory 202 comprises a neural network configuration 202A and one or more buffer memories 202B. In some embodiments, as depicted in FIG. 2, the memory 202 may comprise a plurality of buffer memories 202B, such as, buffer memory 1, buffer memory 2, . . . buffer memory M. The neural network configuration may comprise a computational model composed of nodes, for instance, nodes organized in layers. A node may refer to an artificial neuron, or simply a neuron, and performs a function on an input that is provided to the node and produces an output value. The neural network configuration may also comprise a computational model composed of gates that are typically implemented in recurrent neural networks. In some embodiments, the neural network configuration may define connections amongst the nodes and/or the gates. In some embodiments, the neural network configuration may define weights for the connections. The weights typically are learnt through training of the neural network.

In some embodiments, the processor 201 may be a neural processor. In some embodiments, the processor 201 may correspond to a neural processing unit (NPU). The (NPU) may be a specialized circuit that implements all the necessary control and arithmetic logic necessary to execute machine learning algorithms, typically by operating on models such as artificial neural networks (ANNs), spiking neural networks (SNNs) and event-based neural networks (ENNs). NPUs sometimes go by similar names such as a tensor processing unit (TPU), neural network processor (NNP), and intelligence processing unit (IPU) as well as vision processing unit (VPU) and graph processing unit (GPU). According to some embodiments, the NPUs may be a part of a large SoC, a plurality of NPUs may be instantiated on a single chip, or they may be a part of a dedicated neural-network accelerator. The neural processor may also correspond to a fully connected neural processor in which processing cores are connected to inputs by the fully connected topology. Further, in accordance with an embodiment of the disclosure, the processor 201 may be an integrated chip, for example, a neuromorphic chip.

As seen in FIG. 2, the system 200 may comprise an input interface 203 and an output interface 204. The input interface 203 and the output interface 204 may comprise at least one of a local bus interface, a Universal Serial Bus (USB) interface, an Ethernet interface, a Controller Area Network (CAN) bus interface, a serial interface using a Universal Asynchronous Receiver-Transmitter (UART), a Peripheral Component Interconnect Express (PCIe) interface, or a Joint Test Action Group (JTAG) interface. Each of these buses can be a network on a chip (NoC) bus. According to some embodiments, the input interface 203 and the output interface 204 may further include sensor interfaces that can include one or more interfaces for pixel data, audio data, analog data, and digital data. Sensor interfaces can also include an AER interface for DVS pixel data.

In some embodiments, the input interface 203 may be configured to receive data as input. Also, the input interface 203 is configured to receive input messages generated by neurons in the neural network on particular cores of the processor 201. In some embodiments, the output interface 204 may include any number and/or combination of currently available and/or future-developed electronic components, semiconductor devices, and/or logic elements capable of receiving input data from one or more input devices and/or communicating output data to one or more output devices. According to some embodiments, a user of the system 200 may provide a neural network model and/or input data using one or more input devices wirelessly coupled and/or tethered to the output interface 204. The output interface 204 may also include a display interface, an audio interface, an actuator sensor interface, and the like.

The system 200 may further include a host system 205 comprising a host processor 205A and a host memory 205B. In some embodiments, the host processor 205A may be a general-purpose processor, such as, for example, a state machine, a high-throughput MIC processor, a network or communication processor, a compression engine, a graphics processor, a general-purpose computing graphics processing unit (GPGPU), an embedded processor, or the like. The processor 201 may be a special purpose processor that communicates/receives instructions from the host processor 205A. The processor 201 may recognize the host-processor instructions as being of a type that should be executed by the host-processor 205A. Accordingly, the processor 201 may issue the host-processor instructions (or control signals representing host-processor instructions) on a host-processor bus or other interconnect, to the host-processor 205A.

In some embodiments, the host memory 205B may include any type or combination of volatile and/or non-volatile memory. Examples of volatile memory include various types of random-access memory (RAM), such as dynamic random access memory (DRAM), synchronous dynamic random-access memory (SDRAM), and static random access memory (SRAM), among other examples. Examples of non-volatile memory include disk-based storage mediums (e.g., magnetic and/or optical storage mediums), solid-state storage (e.g., any form of persistent flash memory, including planar or three dimensional (3D) NAND flash memory or NOR flash memory), a 3D Crosspoint memory, electrically erasable programmable read-only memory (EEPROM), and/or other types of non-volatile random-access memories (RAM), among other examples. Host memory 205B may be used, for example, to store information for the host-processor 205A during the execution of instructions and/or data.

The system 200 may further comprise a communication interface 206 having a single, local network, a large network, or a plurality of small or large networks interconnected together. The communication interface 206 may also comprise any type or number of local area networks (LANs) broadband networks, wide area networks (WANs), and a Long-Range Wide Area Network, etc. Further, the communication interface 206 may incorporate one or more LANs, and wireless portions and may incorporate one or more various protocols and architectures such as TCP/IP, Ethernet, etc. The communication interface 206 may also include a network interface to communicate via offline and online wireless communication with networks, such as the Internet, an Intranet, and/or a wireless network, such as a cellular telephone network, a wireless local area network (WLAN), personal area network, and/or a metropolitan area network (MAN). Wireless communication may use any of a plurality of communication standards, protocols, and technologies, such as LTE, 5G, beyond 5G networks, Wireless Fidelity (Wi-Fi) (such as IEEE 802.11, IEEE 802.11b, IEEE 802.11g, IEEE 802.11n, and/or any other IEEE 802.11 protocol), voice over Internet Protocol (VoIP), Wi-MAX, Internet-of-Things (IoT) technology, Machine-Type-Communication (MTC) technology, a protocol for email, instant messaging, and/or Short Message Service (SMS).

The system 200 may further comprise a power supply management unit 207 and pre-and-post-processing units 208. The pre-and-post-processing units 208 may be configured to perform several tasks, such as but not limited to reshaping/resizing of data, conversion of data type, formatting, quantizing, image classification, object detection, etc. whilst maintaining the same layered neural network architecture.

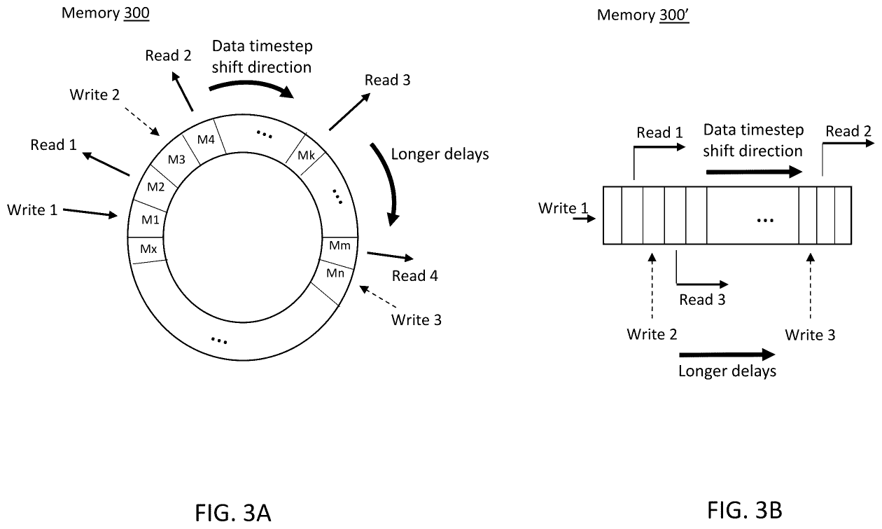

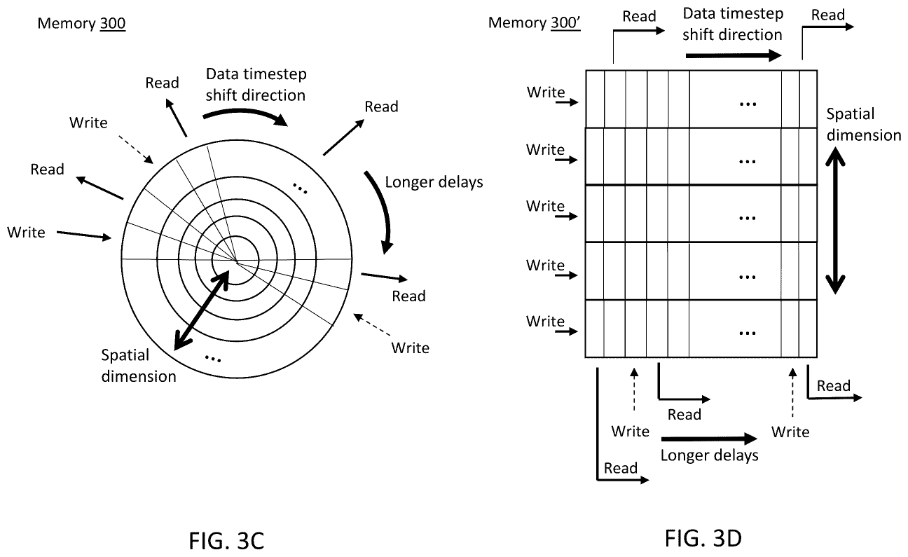

Reference is made to FIG. 3A that illustrates schematically a time series memory 300 for implementing in a neural network. The time series memory 300 may act as a storage of temporal data discretized as a time series for one or more timesteps. As used herein, the terms “time series memory” and “memory” are used interchangeably in the present disclosure. In a non-limiting example, the memory 300 may be a circular buffer memory. It is appreciated that the term ‘circular’ is intended to refer to the implementation of the memory by means of handling memory pointers to different memory locations (i.e., rather than shifting the data in the memory at every timestep, the address associated with one or more memory pointers may be shifted), and is not intended to limit the term in the mechanical sense to a circular shape. The memory 300 may comprise a plurality of memory elements configured for storing data, in that, data may be written to a specific memory element of the memory and data may be read from a specific memory element of the memory. As seen in FIG. 3A, the memory 300 may comprise a plurality of memory elements M1, . . . . Mn, . . . . Mx. In some embodiments, the plurality of memory elements M1-Mx may define a length or a size of the memory 300, thereby defining a data storage capacity of the memory 300. As an example, ‘n’ and ‘x’ are any positive real number equal to or larger than 1.

The data may be stored at a particular memory element in the memory 300 by means of a write function. As seen in FIG. 3A, data may be stored at a memory element M1 by writing the data (for instance, data from an operator, as will be described in detail further below) at the memory element M1, depicted by arrow ‘write 1’. In some embodiments, multiple write functions may be implemented, such as functions shown by arrows ‘write 2’ and ‘write 3,’ at different memory elements of the memory 300. As seen in FIG. 3A, data may be stored in the memory 300 at memory element M3 by means of a write function shown by arrow ‘write 2’ while data may be stored in the memory 300 at memory element Mn by means of a write function shown by arrow ‘write 3’. Further, data may be read from the memory 300, in particular, from different memory elements of the memory 300. For instance, as seen in FIG. 3A, data may be read from memory element M2 as shown by arrow ‘read 1,” from memory element M4 as shown by arrow ‘read 2,’ from memory element Mk as shown by arrow ‘read 3,’ and from memory element Mm as shown by arrow ‘read 4’.

Accordingly, data may be written to the memory 300 at one memory element and read from the memory 300 from different memory elements, the different memory elements defining a delay between the data being written and the data being read from the memory 300. In an exemplary embodiment, as seen in FIG. 3A, the delay between data written at memory element M1 by function ‘write 1’ and the data being read from the memory 300 increases in the clockwise direction, as marked by ‘data timestep shift direction’. That is, at every timestep the data is shifted by one (or more) memory cell, as indicated, or, the memory address in one or more pointers are shifted instead along an opposite direction, which are topologically equivalent. In other words, longer delays between the data written at memory element M1 by function ‘write 1’ and the data being read from the memory 300 may be achieved as data is being read from memory elements further in the clockwise direction of the memory 300. By varying the relative write and read positions, the delay between various elements in the network may be varied. By providing multiple read memory elements, multiple delays can be generated on one data stream. As seen with reference to FIG. 3A, multiple reads permit to use the memory 300 for an operator implementing a temporal convolution. Depending on the delays needed, being able to write to multiple memory elements may also establish multiple delay lines in parallel in a single memory buffer using a single or multiple data streams. Shifting the data by more than one memory element, writing to and reading from multiple memory elements is useful for an operator in combining multiple data streams by using a single memory. It is appreciated that although a clockwise direction of the memory 300 is being depicted, the data may not move within the memory in clockwise or anti-clockwise direction, rather, respective pointers may be utilized to point to data at different memory elements and to instantiate the delays. That is, FIG. 3A presents moving data from one memory element of the memory 300 to another memory element for illustration and communication purposes. Further, pointers rotating counterclockwise may be used to store and retrieve the latest value(s), whereas pointers staying behind in the rotation, may point to delayed values of different delays depending on their relative location to the latest value pointers.

Reference is made to FIG. 3B that illustrates schematically another memory 300′ for implementing in a neural network. In a non-limiting example, the memory 300′ may be a non-circular buffer memory. The memory 300′ may comprise a plurality of memory elements similar to the memory 300 of FIG. 3A. Further, data may be written to the memory 300′ at one memory element, as shown by arrow ‘write 1’ and data may be read from the memory 300′ from different memory elements, as shown by arrows ‘read 1,’ ‘read 2,’ and ‘read 3’. Further, in some embodiments, data may be written at multiple different memory elements, as shown by arrows ‘write 2’ and ‘write 3’. In the embodiment shown in FIG. 3B, longer delay between data read from different memory elements may be achieved, as depicted by ‘data timestep shift direction,’ from a left to right direction of the memory 300′. It is appreciated that the directions depicted for memory 300, 300′ are for illustrative purposes only and in practice, pointers may be provided for memory elements of the memory 300, 300′ in order to write data to the memory 300, 300′ and/or read data from the memory 300, 300′. Further, it is appreciated that the number of write and read arrows shown in FIGS. 3A-3B are not limited as depicted, rather, any number of write and read functions may be provided to write data to the memory and read data from the memory. In a non-limiting example, the memory 300′ may be a first-in-first-out (FIFO) buffer memory. In this case, the ‘Write 1’ pushes the value of the data at a timestep into memory and the last cell on the right, in the orientation as seen in FIG. 3B, is read (not shown), with no other ‘write’ and ‘read’ being performed.

In some embodiments, data may be obtained in a spatial dimension. Reference is made to FIGS. 3C and 3D that illustrate schematically a memory 300, 300′ for implementing in a neural network, a storage of spatiotemporal data discretized as a time series for one or more timesteps. For instance, as seen in FIGS. 3C and 3D, data from the memory 300, 300′ may be obtained in spatial dimension. Each data may be discretized in a spatial dimension, and further, may be stored in memory 300, 300′ depicted in FIG. 3C-3D to provide for delayed streams of the data with one or more spatial and other types of dimension(s).

In some embodiments, the processor 201 of the system 200 shown in FIG. 2 may access the memory 300, 300′ in order to write and/or read data from the memory 300, 300′. In some embodiments, the memory 300, 300′ may form a part of the memory 202 depicted in FIG. 2. In some embodiments, the processor 201 may provide multiple flow paths from the memory 300, 300′ based on writing and/or reading the data from different memory elements of the memory 300, 300′, as will be described in detail further below.

In some embodiments, the processor 201 may be configured to process data in the neural network. The neural network may comprise one or more operators (described hereinafter) and one or more memories associated with the one or more processors. In some embodiments, the neural network may comprise a combination of a plurality of operators and a plurality of associated memories. The operators may be provided with the functionality to fetch data from one of the one or more memory elements from the one or more memories, process the data to generate an output, and store the output in another of the one or more memories. The operators may be provided with the functionality to fetch spatiotemporal time series data stored in one or more memory elements from the one or more memories in order to process one or more input data differentially both along the space, time, and potentially other dimensions of the one or more memories to generate one or more time series data stream at the one or more output(s) corresponding to the operators.

In some embodiments, the operator in the neural network may be a combining operator. In some embodiments, the combining operator in the neural network may be one of a concatenation operator, a multiplication operator, an addition operator, a convolution operator, an integration operator, an autoregressive operator, and any other combining operator that may be configured to read at least more than one discretized spatiotemporal time series data value from the one or more memory elements of one or more memories 300, 300′. The combining operator as detailed above may further be configured to process the data in the memory elements and generate one or more discretized time series data value(s) at the one or more output(s) associated with the combining operator.

Further, the operators as detailed above may be configured to process time series data, i.e., a spatiotemporal data. The spatiotemporal time series data may be stored in the memory elements of the one or more memories as a time series. The spatiotemporal timeseries data may be the operators that operate on time series and generate new time series data as an output. In some embodiments, the output may also be a spatiotemporal time series data.

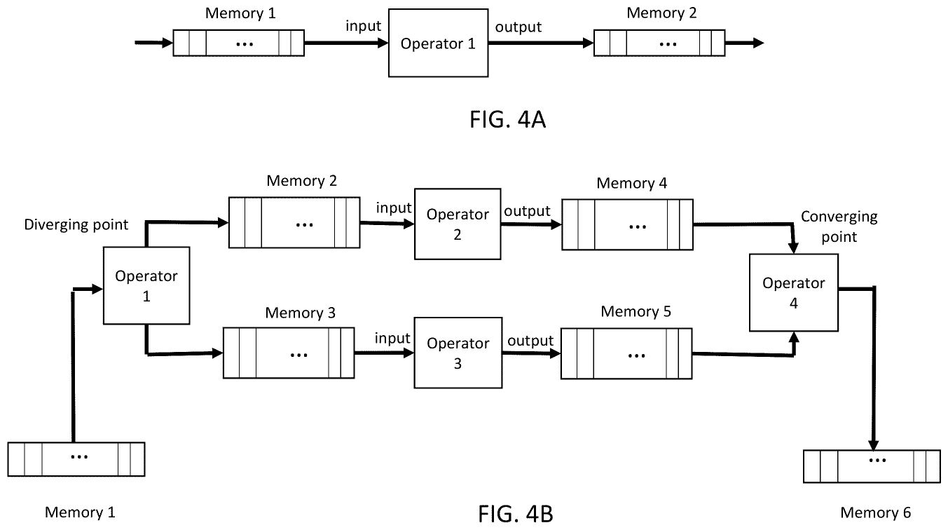

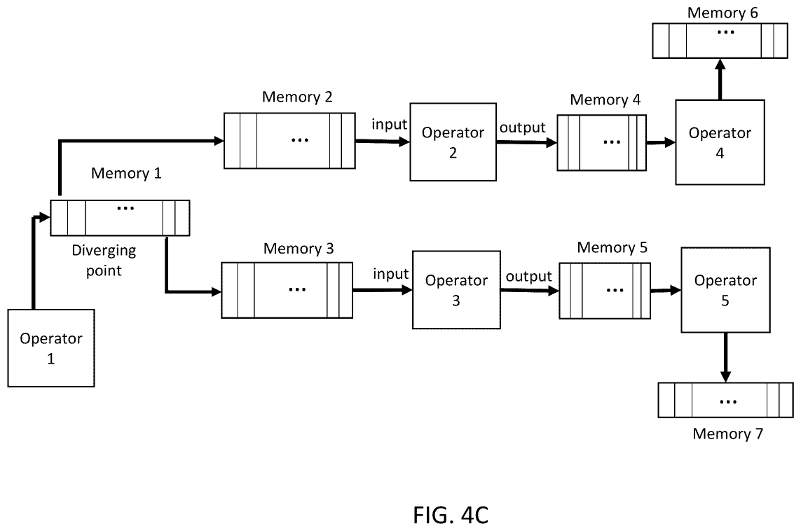

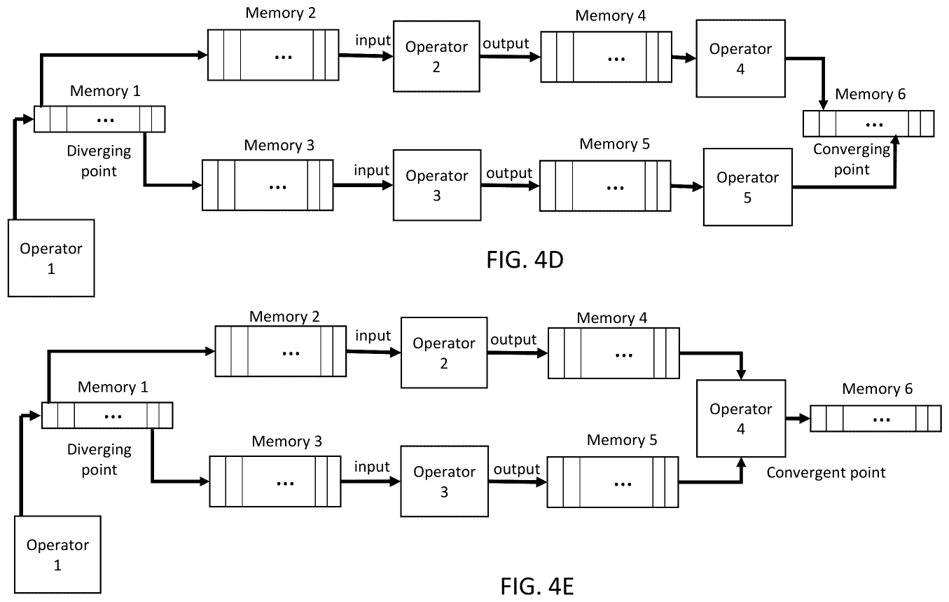

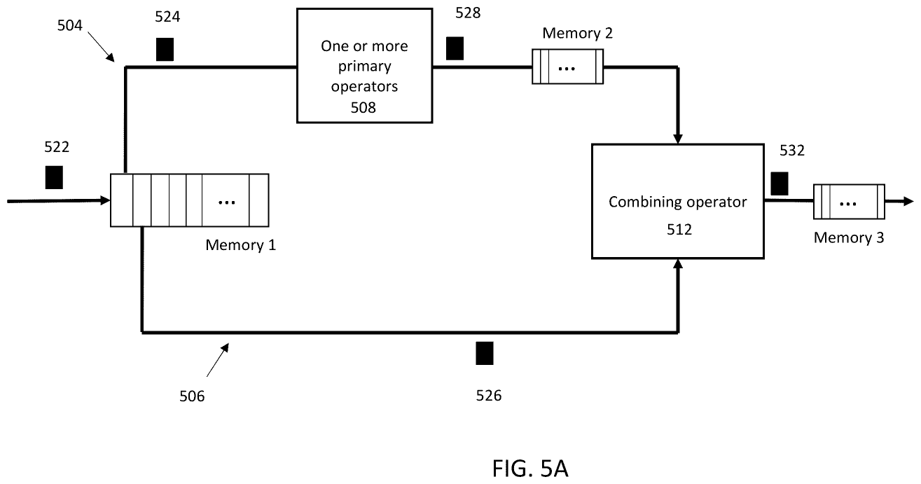

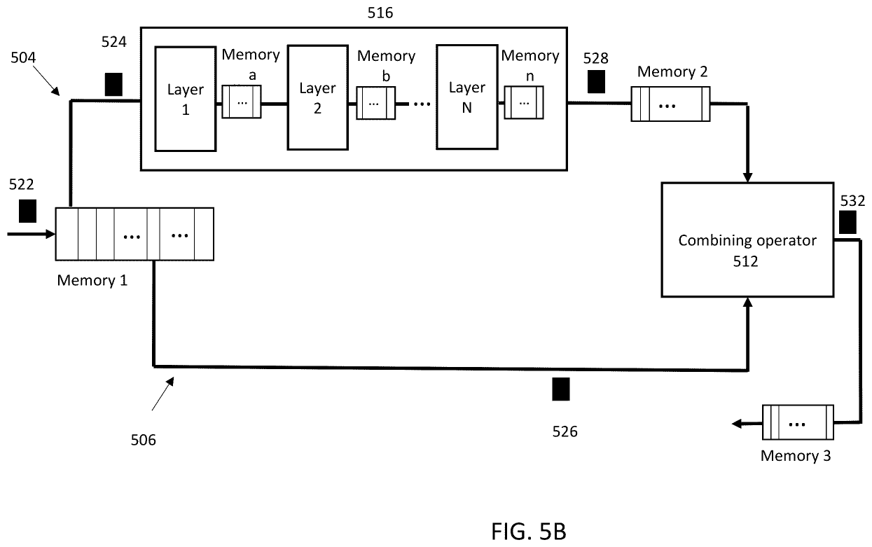

Reference is made to FIG. 4A which illustrates an operator-memory in series configuration, that is one after the other in series, in accordance with one embodiment of the disclosure. As seen in FIG. 4A, operator 1 is associated with memory 1 and memory 2. The operator 1 may fetch (or read) data that is stored in memory 1 as an input, in that, operator 1 may fetch data as an input from a memory element of the memory 1. The operator may process the data and generate an output, and further, the output may be written to the memory 2, in particular, at a memory element of the memory 2. In some embodiments, the memory 1 may be a data bus and the operator 1 may fetch data from the data bus. Accordingly, a flow path is provided in which data is read from the memory 1 and provided as an input to the operator 1, the input is processed by the operator 1 to generate an output, and the output is written to the memory 2. It is appreciated that the term ‘flow path’ refers to an imaginary depiction of flow of data within the neural network, and the term ‘flow path’ may not be interpreted as a physical channel between any two entities.

Reference is made to FIG. 4B which illustrates an operator-memory in parallel configuration, in that, one or more flow paths are in parallel after a diverging point and before a converging point, in accordance with another embodiment of the disclosure. As seen in FIG. 4B, the operator 1 may read data from memory 1 and process the data to generate an output. In the embodiment depicted in FIG. 4B, the operator 1 may write the output to memory 2 and memory 3, for instance, at a corresponding memory element of memory 2 and memory 3 respectively. Two flow paths may thus be provided from the operator 1, and the operator 1 may act as a diverging point within the neural network. Further, in one of the two flow paths, operator 2 may read data from memory 2 as an input, process the data to generate an output, and write the output to the memory 4. In another of the two flow paths, operator 3 may read data from memory 3 as an input, process the data to generate an output, and write the output to the memory 5. Furthermore, operator 4 may read data from both the memory 4 and the memory 5, process the data to generate an output, and write the output to the memory 6. The operator 4 thus acts as a converging point, and also a combining operator, within the neural network for the two flow paths.

Reference is made to FIG. 4C which illustrates an operator-memory configuration in accordance with another embodiment of the disclosure. As seen in FIG. 4C, the operator 1 may write data to memory 1 and the data may further be provided to memory 2 and memory 3 from different memory elements of memory 1. In one of the two flow paths, the operator 2 reads data that is stored in the memory 2, processes the data to generate an output, and writes the output to memory 4. Further, operator 4 reads the data from memory 4, processes the data to generate an output, and writes the output to memory 6. In another of the two flow paths, the operator 3 reads data that is stored in the memory 3, processes the data to generate an output, and writes the output to memory 5. Further, operator 5 reads the data from memory 5, processes the data to generate an output, and writes the output to memory 7. In the embodiment depicted in FIG. 4C, the memory 1 acts as a diverging point within the neural network as two flow paths are provided from the memory 1. In addition, multiple time-series memories, such as memory 6 and memory 7, may form the output within the neural network generated by distinctive operators, such as operator 4 and operator 5.

Reference is made to FIG. 4D which illustrates an operator-memory configuration in accordance with another embodiment of the disclosure. As seen in FIG. 4D, the operator 1 may write data to memory 1 and the data may further be provided to memory 2 and memory 3 from different memory elements of memory 1. In one of the two flow paths, the operator 2 reads data that is stored in the memory 2, processes the data to generate an output, and writes the output to memory 4. Further, operator 4 reads the data from memory 4, processes the data to generate an output, and writes the output to memory 6. In another of the two flow paths, the operator 3 reads data that is stored in the memory 3, processes the data to generate an output, and writes the output to memory 5. Further, operator 5 reads the data from memory 5, processes the data to generate an output, and writes the output to memory 6. In the embodiment depicted in FIG. 4D, the memory 1 acts as a diverging point within the neural network as two flow paths are provided from the memory 1 while the memory 6 acts as a converging point within the neural network as the operator 4 and operator 5 writes the respective outputs in the memory 6.

Reference is made to FIG. 4E which illustrates an operator-memory configuration in accordance with another embodiment of the disclosure. As seen in FIG. 4E, the operator 1 may write data to memory 1 and the data may further be provided to memory 2 and memory 3 from different memory elements of memory 1. In one of the two flow paths, the operator 2 reads data that is stored in the memory 2, processes the data to generate an output, and writes the output to memory 4. In another of the two flow paths, the operator 3 reads data that is stored in the memory 3, processes the data to generate an output, and writes the output to memory 5. Further, operator 4 reads the data from memory 4 and reads the data from memory 5, processes the data to generate an output, and writes the output to memory 6. In the embodiment depicted in FIG. 4E, the memory 1 acts as a diverging point within the neural network as two flow paths are provided from the memory 1 while the operator 4 acts as a converging point within the neural network as the operator 4 reads data from both the memory 4 and memory 5.

Thus, in reference to the FIGS. 4A-4E, time-series memories and operators configurations include in series configuration, in parallel configuration, configuration in which the diverging and converging points may be operator or time-series memories, and configuration with multiple inputs or multiple outputs. In some embodiments (not shown), multiple inputs may be provided from multiple time series memories. It is appreciated that any other combinations of operators, memories, writing, reading operations, such as those shown in FIGS. 3A-3D, may be obtained by interchanging, connecting, adding, removing, any of one or more of the blocks of one of the FIGS. 4A-4E to any of the other FIGS. 4A-4E.

Further, it is appreciated that although the operator and memory are depicted as separate components, in some embodiments, the memory may be integral with the operator, and a next operator may read data from the memory integral with a previous operator.

In some embodiments, an operator may be configured to receive time series data over multiple paths, the time series data comprising data at continuous time instances one after the other. The operator may be, for instance, a combining operator. In one example, the operator may be configured to receive data from one time instance via one of the multiple paths and data from another time instance via another of the multiple paths. In another example, the operator may be configured to receive data from one time instance via one of the multiple paths and data from the same time instance via another of the multiple paths.

At the operator, a time offset may be realized based on the data being received via the multiple paths, in that, the time offset may be generated at the operator as data may not be received in a synchronized manner at the operator. For instance, data from one time instance may be received at the operator over different paths, such as, a first path and a second path. However, the data from one time instance being received over the first path may be delayed as compared to the same data from one time instance being received over the second path.

Accordingly, at any particular time instance, the same data may or may not be provided at the operator for processing. Rather, at any particular time instance, one data from the time series data may be provided at the operator over one path while another data (earlier in series to the one data or later in series to the one data) from the time series data may be provided at the operator over another path. The operator may thus process data being received in an unsynchronized manner at the operator, resulting in a time offset being generated when the operator processes the unsynchronized data. That is, the operator may not necessarily process same data being received synchronously over multiple paths, rather, the operator may process one data with another, delayed data, thereby realizing a time offset at the operator.

In some embodiments, the delay may be generated over any of the paths due to one or more factors, such as, but not limited to, various operators being provided on the paths and/or additional memory buffers being provided on the paths. In addition, the extent of delay generated over one of the multiple paths may vary from the extent of delay generated over a different one of the multiple paths. The extent of delay may be related to the processing time for various operators provided on the paths, memory size of the memory buffers provided on the paths, reading positions from the memory buffers provided on the paths, and the like.

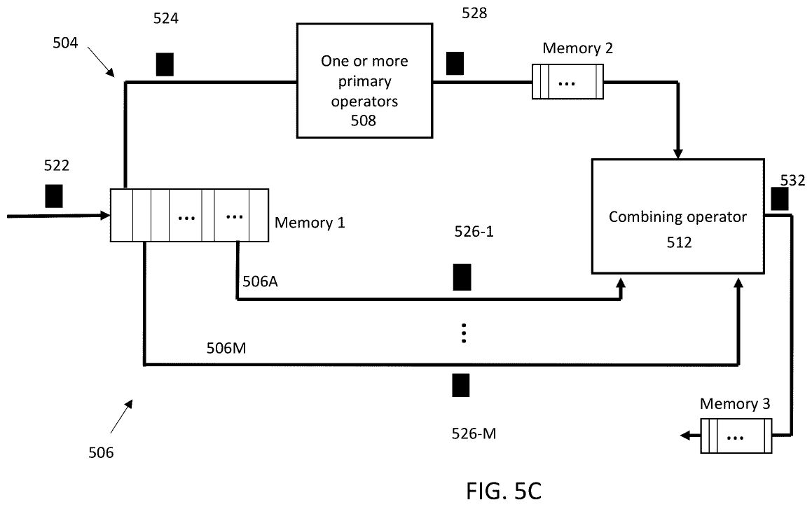

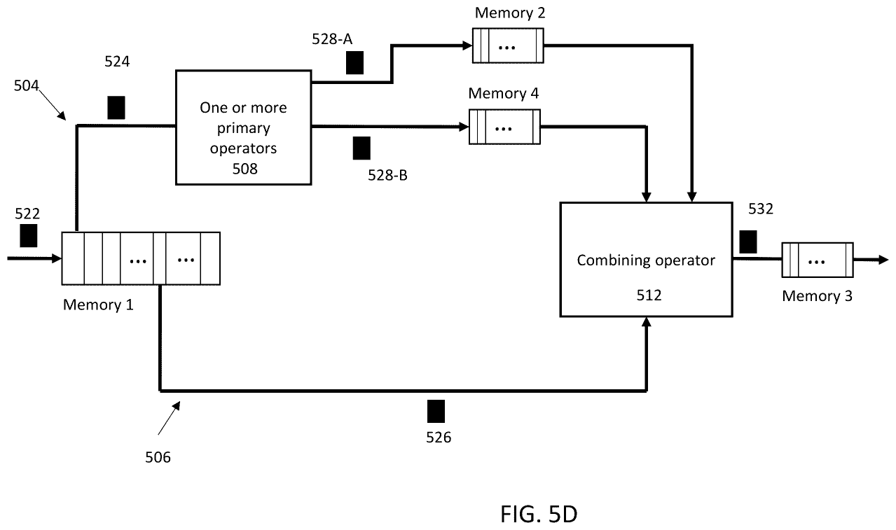

As a result of the delay in one or more paths over which data can be provided to the operator, a time offset is realized by the neural network at the operator since operator may be processing data received in an unsynchronized manner, i.e., with delays. An operator is considered to be operating in an unsynchronized manner or with the time offset when performing an operation at a time instance, the data received by the operator over two or more paths to perform the operation, are not generated based on a common sequence received at an input at a diverging point of the two or more paths. This is explained in detail with description of FIG. 5A.

The neural network thus provides an memory optimized network with the use of offset data processing without the need to add extra memory buffers at various paths in a neural network with skip connections. A memory efficient implementation is thus achieved. This may be particularly beneficial for implementation with limited memory, such as on Edge processing and reducing efforts and time of developers when implementing large and complex skipNN.

Reference is made to FIG. 5A depicting an exemplary representation of a flow of a sequence of data in an operator-memory configuration within a neural network, in accordance with an embodiment of the disclosure. In some embodiments, a processor, such as processor 201 shown in FIG. 2, may be configured to process a main sequence of data (522) in the neural network. The processor may be associated with a memory comprising a plurality of memory elements. The processor may be configured to provide the main sequence of data (522) to the memory, for instance, to memory 1 depicted in FIG. 5A. In some embodiments, the main sequence of data (522) may be written in the memory 1 at respective memory elements. In some embodiments, the memory 1 may be similar to the buffer memory 202B shown in FIG. 2.

In some embodiments, the processor may be configured to provide a primary flow path 504 and at least one secondary flow path 506 from the memory 1. The primary flow path 504 may be associated with a primary sequence of data (524) from the main sequence of data (522) while the at least one secondary flow path 506 may be associated with a secondary sequence of data (526) from the main sequence of data (522). In some embodiments, the primary sequence of data (524) may be read from a first memory element of the memory 1 while the secondary sequence of data (526) may be read from a second memory element of the memory 1 which is different from the first memory element of the memory 1. The memory 1 may comprise a plurality of memory elements associated with the primary flow path 504 and the at least one secondary flow path 506 within the neural network and the primary sequence of data and the secondary sequence of data may be read from a different memory element of the plurality of memory elements associated with the memory 1. In some embodiments, the memory 1 comprise only one memory element that is used and overwritten. The data can be temporal data, spatiotemporal data (e.g., video data) or spatial data (e.g. image), or more generally, spatiotemporal data with including data related to other dimensions.

As described above, the memory 1 may comprise a plurality of memory elements and multiple flow paths may be provided from the memory 1. A time offset may be provided between the main sequence of data (522), the primary sequence of data (524), and the secondary sequence of data (526) based on the memory elements within the memory 1 from which the data may be read. For instance, a delay of one sequence of data can be provided by reading the two sequences of data from subsequent memory elements of the memory 1.

In some embodiments, the main sequence of data is time series data. For example, a video can be categorized as time series data, and fed as a series of frames to a network that implements skip connection. In this scenario, the time offset (non-synchronized operation) could be implemented on the merging point when the inputs are generated based on the different frames of the video.

In some embodiments, the main sequence of data is spatial or non-time series data. For example, a single camera image can be categorized as non-time series data, yet, it can be partitioned and fed one partition at a time to a network that implements skip connection. The time offset (non-synchronized operation) could be implemented at the merging point, for example, for portioned images.

In some embodiments, the secondary sequence of data is time offset from the processed primary sequence of data such that time offset value associated with time offset is of any integer except 0.

In some embodiments, the secondary sequence of data is time offset from the processed primary sequence of data such that time offset value associated with time offset is of any integer except 0 and 1 (skip-1).

It should be appreciated that the proposed invention considers network connections to have any delay values, or time offsets.

In some embodiments, the secondary sequence of data from the at least one secondary flow path may be time offset from the processed primary sequence of data from the primary flow path by a dynamic time offset value, and the processor may be configured to vary the dynamic time offset value. In some embodiments, the primary sequence of data may be time offset from the main sequence of data by a first time offset value and the secondary sequence of data may be time offset from the main sequence of data by a second time offset value, the first time offset value and the second time offset value defining the time offset between the primary sequence of data and the secondary sequence of data. In other words, a first time offset value may be obtained between the main sequence of data (522) and the primary sequence of data (524), the first time offset value defining the time offset between the main sequence of data (522) and the primary sequence of data (524). In some embodiments, a second time offset value may be obtained between the main sequence of data (522) and the secondary sequence of data (526), the second time offset value defining the time offset between the main sequence of data (522) and the secondary sequence of data (526). In some embodiments, the first time offset value and the second time offset value defines the time offset between the primary sequence of data (524) and the secondary sequence of data (526) that gets combined (processed) at a combining operator 512.

As depicted in FIG. 5A, the primary flow path 504 may comprise one or more primary operators 508 and the processor may be configured to provide the primary sequence of data (524) from the memory 1 to the one or more primary operators 508. The one or more primary operators may be configured to process the primary sequence of data (524) and generate a processed primary sequence of data (528). That is, the processor may provide the processed primary sequence of data (528) from the one or more primary operators based on the processing of the primary sequence of data (524) by the one or more primary operators. In some embodiments, the processor may cause the one or more primary operators to write the processed primary sequence of data (528) to a memory, such as memory 2 depicted in FIG. 5A, and further, the processed primary sequence of data (528) may be provided to the combining operator 512.

In some embodiments, the main sequence of data (522) may comprise time series data that may be provided to the memory 1. The secondary flow path 506 provides the secondary sequence of data (526) to a combining operator 512 without processing at any primary operator while the primary flow path 504 provides the primary sequence of data (524) to the primary operators 508, and further, the processed primary sequence of data (528) is provided to the combining operator 512. As a result of the presence of the one or more primary operators 508 at the primary flow path 504, a delay may be added to the processed primary sequence of data (528) due to processing of the primary sequence of data (524) by the one or more primary operators 508.

At different time instances associated with the received time series data, the time series data may comprise data A and data B. The data A and data B may be received at the memory 1, i.e., written to the memory 1 as the data is being received at the memory 1. For instance, at a first time instance, data A is received at the memory 1 and written at a first memory element of the memory 1. At a second time instance, data A is read from the memory 1 from the first memory element, as seen in FIG. 5A, and provided to the one or more primary operators 508. At the same second time instance, the next data B may be received at the memory 1 and written at the first memory element of the memory 1.

At a third time instance, the one or more primary operators 508 may process the data A to generate an output of data A, say data A′. In the above scenario, it is assumed that the processing time of the one or more primary operators 508 is equivalent to one time instance. It is appreciated that in other embodiments, the processing time for the one or more primary operator 508 may vary to be greater than one time instance. At the same third time instance, the data B may be received to the second memory element of the memory 1.

At a fourth time instance, the processed data A′ may be provided to the combining operator 512. At the same fourth time instance, the data B may be read from the second memory element of the memory 2, as seen in FIG. 5A, and provided to the combining operator 512. As a result, at a same time instance, i.e., the fourth time instance:
over the primary flow path 504, the output of data A, that is, the processed data A′ is provided to the combining operator 512,
over the secondary flow path 506, the data B is provided to the combining operator 512 without any processing over the secondary flow path 506.

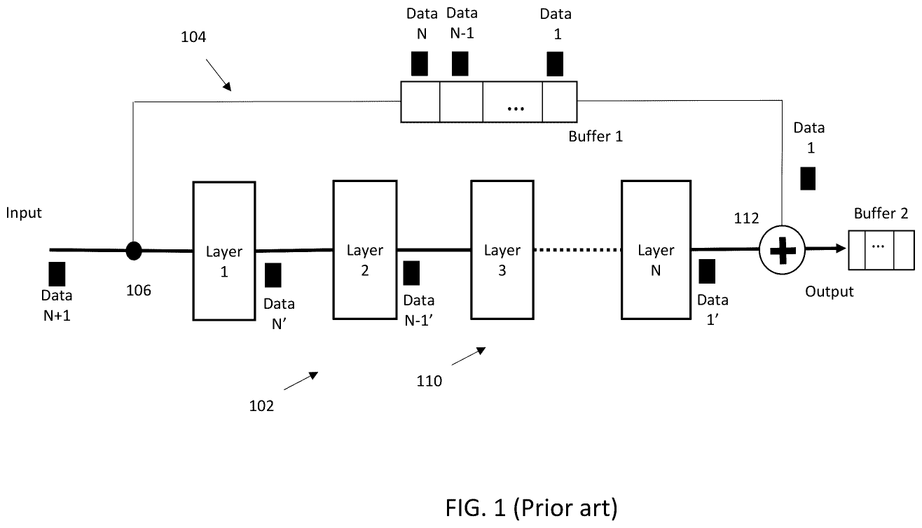

At the combining operator 512, the output of data A (data A′) and data B is received for processing. In the illustrated embodiment, the data B is provided over the secondary flow path without a delay while a delay is added to the data A′ being provided over the primary flow path. The combining operator 512 thus processes data B provided over the secondary flow path 506 and output of data A (data A′) provided over the primary flow path 504. As a result of the delay, a time offset is realized by the neural network as data A is not processed with output of data A, rather, data B is processed with output of data A. Accordingly, the network configure the combining operator to process data with the time offset (without synchronization), and provides a memory efficient network without the need to add extra memory buffers at various paths in a neural network that includes skip connections. It should be noted from FIG. 1 that prior art necessarily combines the data with no time offset (with synchronization). For example, additional memory is used to add delay in secondary flow path 506, so that at the combining operator, output of data A (A′) received by the primary flow path 504 and data A received over secondary flow path 506 are processed together.

In the illustrated embodiment, a time offset of 1 is realized at the combining operator 512, since the processing time of the one or more primary operators 508 is considered as one time instance, while the data B is read from the second memory element of the memory 1, as illustrated in FIG. 5A. The time offset of 1 may be considered as a positive time offset as the combining operator processes output of data A (data A′) with data B, where data B sequentially follows data A in the time series data.

In alternative embodiments, the combining operator 512 may process output of data B (for instance, data B may be read from the memory 1 and provided over the primary flow path 504) with data A (provided over the secondary flow path 506), still achieving a time offset at the combining operator, the time offset being a negative time offset.

In other exemplary embodiments, the extent of the time offset may be varied based on the number of operators provided in the primary flow path 504 and/or the secondary flow path 506, the processing time of each of the operators provided in the primary flow path 504 and/or the secondary flow path 506, the reading time from the memory 1 of the time series data, and/or presence of additional memory buffers on the primary flow path 504 and/or the secondary flow path 506. As an example, in the illustrated embodiment, the processing time of the one or more primary operators 508 may be considered as three time instances, and at the combining operator, a time offset of three may be realized.

In some embodiments, as depicted in FIG. 5A, one or more primary operators acting on the primary sequence of data may generate a processed primary sequence of data (528) that is time offset compared to the primary sequence of data (524) because the processing by the one or more primary operators may not be instantaneous or be fully completed within the interval of a timestep. Hence, in addition to modifying the sequence of data by operating on it, the one or more primary operators generate a time offset in the output sequence compared to the input sequence.

Further, the processor may be configured to provide the at least one secondary flow path 506 from the memory 1 with the secondary sequence of data (526) of the main sequence of data (522). As described above, the primary sequence of data (524), and consequently the processed primary sequence of data (528), may be read from a first memory element of the memory 1 while the secondary sequence of data (526) may be read from a different, second memory element of the memory 1, thus leading to varying the extent of time offset that can be achieved at the combining operator 512.

Further, the processor may be configured to provide the processed primary sequence of data (528) to the combining operator 512. In some embodiments, the processed primary sequence of data (528) may be provided to the combining operator 512 from the memory 2. In some embodiments, the processor is configured to generate the output data at the combining operator based on a merging operation on the at least one sequence of data from the processed primary sequence of data and the at least one sequence of data from the secondary sequence of data. The combining operator may be, for instance, a concatenation operator, a multiplication operator, an addition operator, a convolution operator, an integration operator, an autoregressive operator, or any other combining operator that may be configured to read at least more than one discretized spatiotemporal time series data value from the one or more memory elements of one or more memories 300, 300′. The combining operator as detailed above may further be configured to process the data in the memory elements and generate one or more discretized time series data value(s) at the one or more output(s) associated with the combining operator. Furthermore, the processor may be configured to provide the secondary sequence of data (526) to the combining operator 512, the secondary sequence of data (526) being provided from the memory 1. As depicted in FIG. 5A, processor may be configured to pass the secondary sequence of data (526) to the combining operator 512 directly, i.e., without processing by the one or more primary operators. In other words, the at least one secondary sequence of data may pass data to the combining operator by skipping the processing of the data over the primary flow path 504. One consequence is that, instead of keeping the processed primary sequence of data (528) and the secondary sequence of data (526) synchronous at the combining operator 512, a time offset is purposely generated between the sequences arriving at the combining operator 512; the time offset being a consequence of the one or more primary operators processing time delay and the relative time offset between the two sequences generated at reading time in memory 1.

The processor may be configured to receive the processed primary sequence of data (528) from the primary flow path 504 and the secondary sequence of data (526) from the at least one secondary flow path 506 at the combining operator 512. The combining operator 512 may process one or more sequences of data from both the processed primary sequence of data (528) and secondary sequence of data. In some embodiments, output data may be generated at the combining operator 512 based on processing of at least one sequence of data from the processed primary sequence of data (528) and at least one sequence of data from the secondary sequence of data (526). In some embodiments, the processor may provide the output data to a memory 3, and the output data may further be provided to further operators within the neural network.

In some embodiments, the processor may cause the combining operator 512 to perform a merging operation on the processed primary sequence of data (528) and the secondary sequence of data (526). In particular, the processor may be configured to perform at the combining operator 512, a merging operation on at least one sequence of data from the processed primary sequence of data (528) and at least one sequence of data from the secondary sequence of data (526). Accordingly, the output data may be generated at the combining operator 512 based on the merging operation on at least one sequence of data from the processed primary sequence of data (528) and at least one sequence of data from the secondary sequence of data (526).

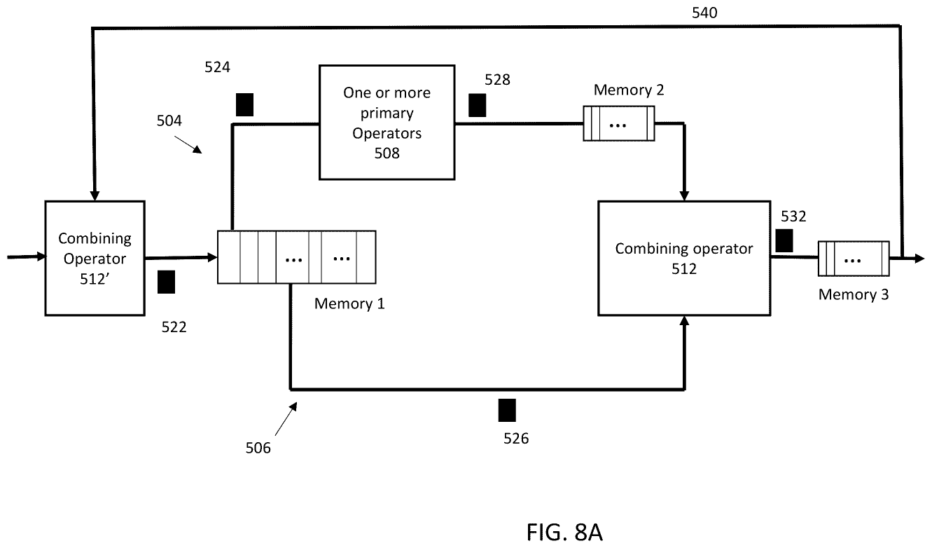

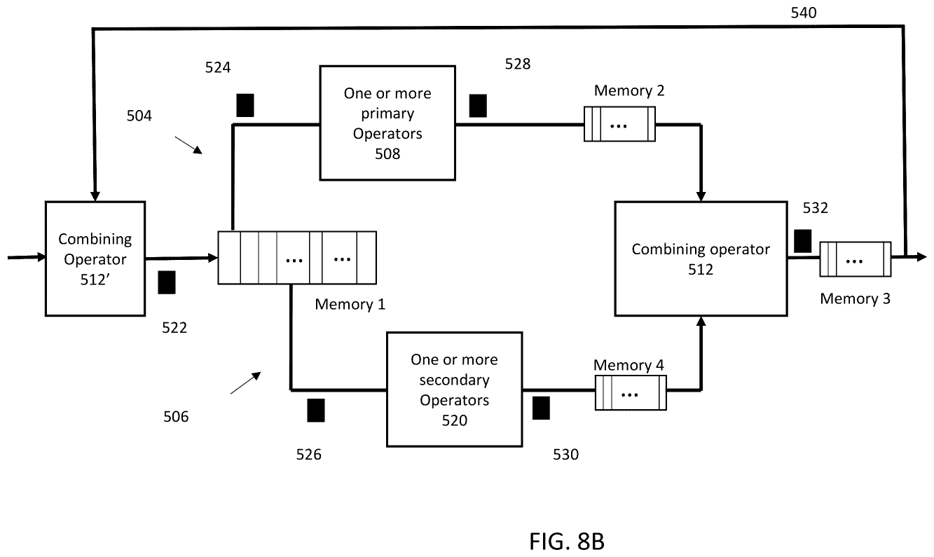

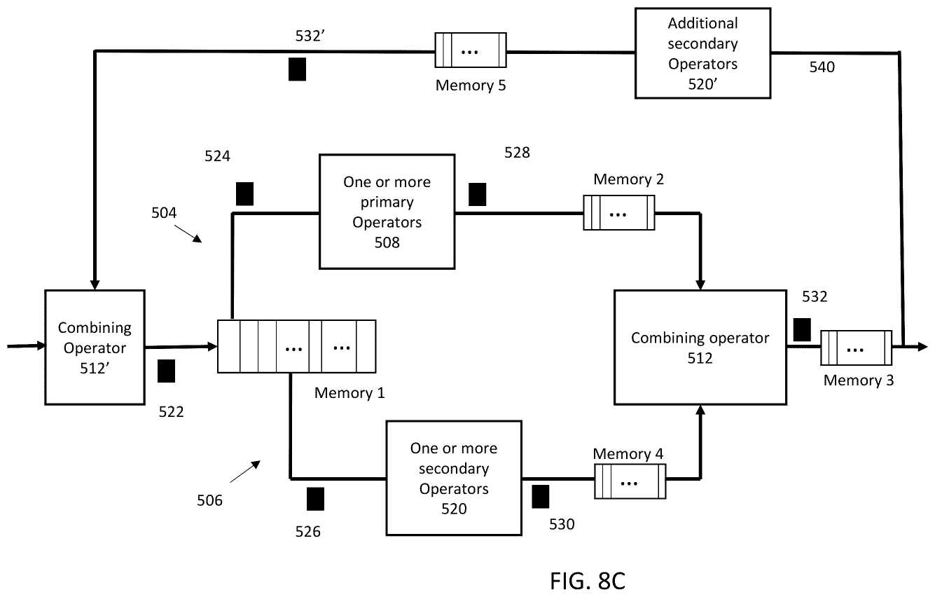

In some embodiments, the main sequence of data 522 may be provided to the memory 1 from another combining operator in the neural network. Referring to FIG. 8A, an exemplary representation of a flow of a sequence of data in an operator-memory configuration within a neural network, in accordance with another embodiment of the disclosure. The configuration depicted in FIG. 8A is similar to the configuration depicted in FIG. 5A, and additionally, a combining operator 512′ may be provided that is configured to generate the main sequence of data 522 to be provided to the memory 1. As depicted in FIG. 8A, the combining operator 512′ may process the output data 532 that is generated by the combining operator 512, in that, the neural network may comprise a feedback path 540 over which the output data 532 may be provided to the combining operator 512′. The combining operator 512′ may process the output data 532 along with additional data, such as, from a different memory within the neural network, so as to generate the main sequence of data 522 that is provided to the memory 1. It is appreciated that the details provided above with respect to processing of data in FIG. 5A is analogously applicable to FIG. 8A as well.

In some embodiments, the one or more primary operators 508 may comprise a plurality of neural network layers configured to process the primary sequence of data (524) and generate the processed primary sequence of data (528). Reference is made to FIG. 5B which illustrates an exemplary representation of a flow of a sequence of data in an operator-memory configuration within a neural network, in accordance with another embodiment of the disclosure. The configuration depicted in FIG. 5B is similar to the configuration depicted in FIG. 5A, in that, the processor is configured to provide the main sequence of data (522) to the memory 1, provide the primary flow path 504 having the primary sequence of data (524) from the memory 1, and provide the at least one secondary flow path 506 having the secondary sequence of data (526) from the memory 1. Further, as depicted in FIG. 5B, the primary flow path 504 comprises a plurality of neural network layers 516 having layer 1, layer 2, . . . layer N, each associated with a respective memory, i.e., memory a, memory b, . . . memory n. As an example, ‘N’ and ‘n’ may be any positive real number equal to or larger than 1.

In some embodiments, the processor may provide the primary sequence of data (524) from the memory 1 to the plurality of neural network layers 516, and the plurality of neural network layers 516 may be configured to generate the processed primary sequence of data (528) based on the processing of the primary sequence of data (524). In some embodiments, the plurality of layers 516 may comprise a plurality of convolution layers. Further, as depicted in FIG. 5B, the processor may write the processed primary sequence of data (528) to the memory a, memory b, up to memory n, and further, to memory 2. The processed primary sequence of data (528) may further be provided to the combining operator 512. In addition to the processed primary sequence of data (528), the processor may provide the secondary sequence of data (526) from the secondary flow path 506 to the combining operator 512. A time offset is generated at the combining operator 512 as the combining operator 512 processes the processed primary sequence of data (528) and the secondary sequence of data (526) sequences. In some embodiments, at least one of the one or more primary operators and the combining operator comprises a plurality of neural network layers configured to process the data. In some embodiments, the time offset may be determined based on the plurality of layers 516 and their respective delay memories a to n, processing the primary sequence of data (524) while the secondary sequence of data (526) is received unprocessed at the combining operator 512. In other words, the plurality of layers 516 may each have a certain processing time for processing the primary sequence of data, and a delay may be provided to the primary sequence of data 524 due to the processing by the plurality of layers 516 and their respective delay memories-memory a to memory n. The combining operator 512 may process one or more sequences of data from both the primary and secondary sequences of data in order to generate output data, and the processor may provide the output data to the memory 3. With the above detailed flow of the sequence of data, there is no need to synchronize the data values from the sequences using additional buffers for the time-series data being received and processed.

In some embodiments, the processor may be configured to provide a plurality of secondary flow paths 506 from the memory 1. Reference is made to FIG. 5C which illustrates an exemplary representation of a flow of a sequence of data in an operator-memory configuration within a neural network, in accordance with another embodiment of the disclosure. The configuration depicted in FIG. 5C is similar to the configuration depicted in FIG. 5A, in that, the processor is configured to provide the main sequence of data (522) to the memory 1 and provide the primary flow path 504 having the primary sequence of data (524) from the memory 1. Further, as seen in FIG. 5C, the at least one secondary flow path 506 may comprise two or more secondary flow paths 506A, . . . 506M, each having a respective secondary sequence of data, such as, secondary sequence of data (526-1), secondary sequence of data (526-2), . . . secondary sequence of data (526-M). It is appreciated that ‘M’ may be a real number greater than 1.

In some embodiments, the processor may be configured to provide each of the two or more secondary flow paths 506 from a different memory element of the memory 1. That is, the processor may be configured to provide a first one of the two or more secondary flow paths from one memory element of the memory 1 and the processor may further be configured to provide a second one of the two or more secondary flow paths 506 from another different memory element of the memory 1. As an example, the processor may be configured to provide the secondary flow path 506A from a memory element of the memory 1 while the processor may be configured to provide the secondary flow path 506M from another memory element of the memory 1.

Accordingly, in the illustrated embodiment, as each of the two or more secondary flow paths 506 may be provided from a different memory element of the memory 1 directly to the combining operator 512, each one of the respective secondary sequence of data may be time offset from each other by a respective time offset value. As an example, the secondary sequence of data (526-1) from the secondary flow path 506A may be time offset from the secondary sequence of data (526-M) from the secondary flow path 506M by a first time offset value. As an example, the secondary sequence of data (526-1) from the secondary flow path 506A may be time offset from the secondary sequence of data (526M) by a second time offset value, where the second time offset value is different from the first time offset value.

In some embodiments, the processor may be configured to generate, at the one or more primary operators 508, two or more processed primary sequence of data (528). In addition to the time offset generated by reading the sequences from different memory locations, a further delay may be achieved by processing of the primary sequence of data (524) at the one or more primary operators 508. Further, the processor may be configured to provide each of the two or more processed primary sequence of data (528) to a respective memory. Reference is made to FIG. 5D which illustrates an exemplary representation of a flow of a sequence of data in an operator-memory configuration within a neural network, in accordance with another embodiment of the disclosure. The configuration depicted in FIG. 5D is similar to the configuration depicted in FIG. 5A, in that, the processor is configured to provide the main sequence of data (522) to the memory 1 and provide the primary flow path 504 having the primary sequence of data (524) from the memory 1. Further, as seen in FIG. 5D, processed primary sequence of data (528-A) and processed primary sequence of data (528-B) may be generated by the one or more primary operators 508.

The processor may be configured to provide the processed primary sequence of data (528-A) to memory 2 and the processed primary sequence of data (528-B) to the memory 4. In some embodiments, the memory 2 and the memory 4 may be provided in parallel to each other. Further, the processor may be configured to provide the processed primary sequence of data (528-A), the processed primary sequence of data (528-B), and the secondary sequence of data (526) to the combining operator 512. In some embodiments, the processed primary sequence of data (528-A) and the processed primary sequence of data (528-B) may be provided to the combining operator 512 parallelly. In some embodiments, the one or more primary operators 508 may each have a different processing time delay, such that the processed primary sequence of data (528-A) and the processed primary sequence of data (528-B) may be provided with a time offset between the processed primary sequence of data (528-A) and the processed primary sequence of data (528-B) at the combining operator 512. The combining operator 512 may process one or more sequences of data from the processed primary sequence of data (528A), the processed primary sequence of data (528-B), and/or the secondary sequences of data in order to generate output data, and the processor may provide the output data to the memory 3.

In some embodiments, as described above, the secondary sequence of data (526) from the at least one secondary flow path 506 may be time offset from the processed primary sequence of data (528) from the primary flow path 504. In some embodiments, the secondary sequence of data from the at least one secondary flow path may be time offset from the processed primary sequence of data from the primary flow path by a dynamic time offset value, and the processor may be configured to vary the dynamic time offset value. That is, a dynamic time offset value may be obtained for the time offset between the secondary sequence of data (526) and the processed primary sequence of data (528), in that, the processor may be configured to vary the extent of delay, and thus, the time offset realized at the combining operator 512, by, for example: (i) changing the memory elements in memory 1, 2, or 4 into which the sequence of data is written into, and/or (ii) changing the memory elements in memory 1, 2, or 4 from which to generate the primary sequence(s) of data and/or (iii) changing the memory element in memory 1 from which to generate the secondary sequence of data (526), and/or (iv) dynamically varying the size of each memory buffer, thereby adjusting the time offset. In some embodiments, the primary sequence of data may be time offset from the main sequence of data by a first time offset value and the secondary sequence of data may be time offset from the main sequence of data by a second time offset value, the first time offset value and the second time offset value defining the time offset between the primary sequence of data and the secondary sequence of data.

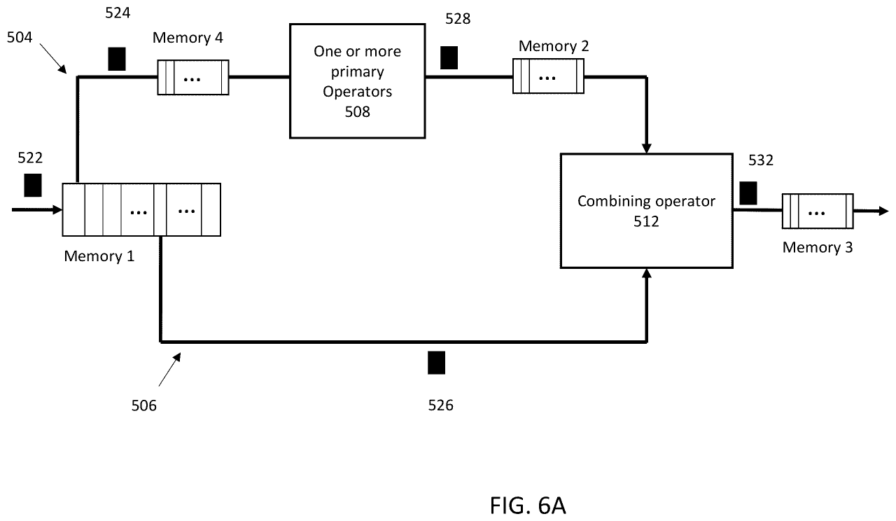

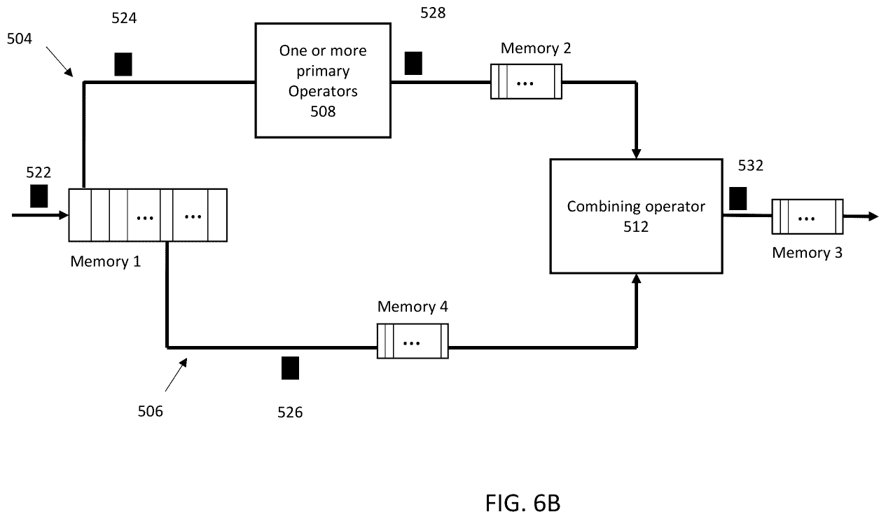

In some embodiments, an additional memory may be provided at the primary flow path 504 and/or the at least one secondary flow path 506. The processor may be configured to write one or more of the primary sequence of data (524), the processed primary sequence of data (528), and the secondary sequence of data (526), to the additional memory, thereby adding additional delays to the processed primary sequence of data (528) and/or the secondary sequence of data (526, and thus, varying the already existing time offset realized at the combining operator that processes the processed primary sequence of data (528) and the secondary sequence of data (526). For instance, as seen in FIG. 6A, a memory 4 may be provided upstream the one or more primary operators such that the primary sequence of data (524) may be provided to the memory 4 prior to providing the primary sequence of data (524) to the one or more primary operators 508. Accordingly, an additional delay may be provided by first writing the primary sequence of data (524) to the memory 4, and then, reading the primary sequence of data (524) from one of the memory elements of memory 4 for the one or more primary operators 508 to achieve a specific time delay.

In some embodiments, the memory 2 may be provided downstream the one or more primary operators 508 such that the processed primary sequence of data (528) may be written to the memory 2 prior to providing the processed primary sequence of data (528) to the combining operator 512 (FIGS. 5A-8C). The memory 2 may be a data storage area that allows further time delay to be generated in the primary sequence of data (524) before being combined with the secondary sequence of data (526) by the combining operator 512. In some embodiments, a memory 2 and memory 4 may be provided both upstream and downstream, respectively, the one or more primary operators 508.

In some embodiments, the memory 4 may be provided at the at least one secondary flow path 506 so as to provide additional delay to the secondary sequence of data (526) being provided to the combining operator 512. As seen in FIG. 6B, the memory 4 is provided at the secondary flow path 506. As described above, delay may be provided between the primary sequence of data (524) and the secondary sequence of data (526) by reading the sequences from different memory elements of the memory 1. Further, delay may also be achieved by processing of the primary sequence of data (524) at the one or more primary operators 508. Moreover, additional delay may be provided in the secondary sequence of data (526) by providing the memory 4 at the secondary flow path 506. An additional delay may be provided by first writing the secondary sequence of data (526) to the memory 4, and then, reading the secondary sequence of data (526) from a specific memory element of the memory 4 for the combining operator 512, thereby achieving a specific additional time delay between the processed primary sequence of data (528) and the secondary sequence of data (526). As a result, the combining operator 512 processes the primary sequence of data (528) and the secondary sequence of data (526) that are at time offset.

In some embodiments, additional memory, such as the memory 2 or 4, may be provided at both the primary flow path 504 and the at least one secondary flow path 506, thereby obtaining a varying time offset.

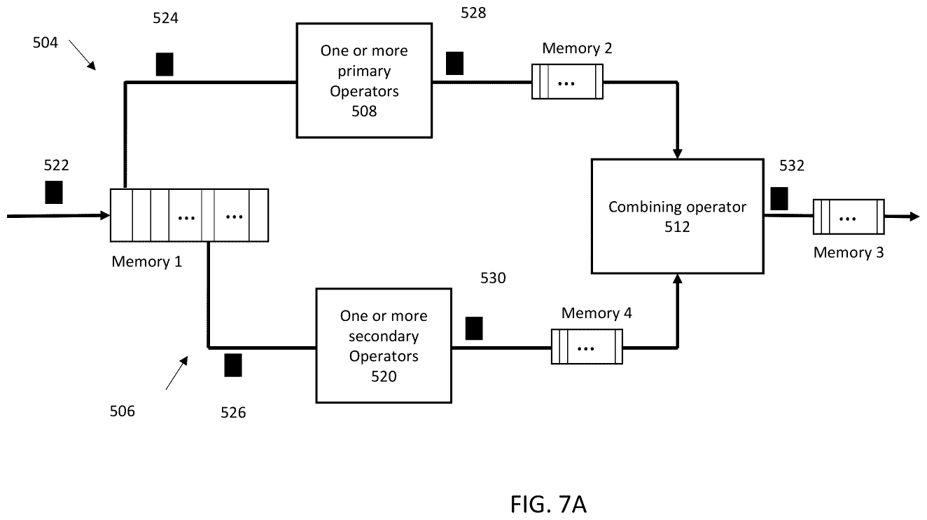

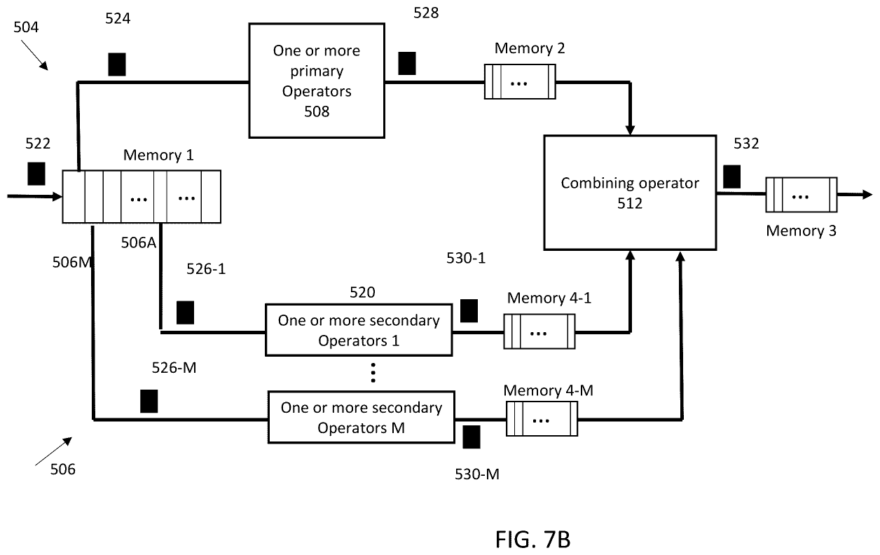

In some embodiments, in addition to the primary flow path comprising the one or more primary operators, the at least one secondary flow path 506 may comprise one or more secondary operators configured to process data. Reference is made to FIG. 7A depicting an exemplary representation of a flow of a sequence of data in an operator-memory configuration within a neural network, in accordance with another embodiment of the disclosure. In some embodiments, a processor, such as processor 201 shown in FIG. 2, may be configured to process the main sequence of data (522) in the neural network. The processor may further be configured to provide the primary flow path 504 and at least one secondary flow path 506 from the memory 1. The primary flow path 504 may be associated with a primary sequence of data from the main sequence of data (522) while the at least one secondary flow path 506 may be associated with a secondary sequence of data from the main sequence of data (522). In some embodiments, the primary sequence of data (524) is time offset from the secondary sequence of data (526), in that, the primary sequence of data (524) may be read from one memory element of the memory 1 while the secondary sequence of data (526) may be read from a different memory element of the memory 1.

The primary flow path 504 may comprise one or more primary operators 508 and the processor may be configured to provide the primary sequence of data (524) from the memory 1 to the one or more primary operators 508. Further, the at least one secondary flow path 506 may comprise one or more secondary operators 520 and the processor may be configured to provide the secondary sequence of data (526) from the memory 1 to the one or more secondary operators 520. The one or more primary operators may be configured to process the primary sequence of data (524) and generate a processed primary sequence of data (528). Further, the one or more secondary operators may be configured to process the secondary sequence of data (526) and generate a processed secondary sequence of data (530). In some embodiments, the one or more primary operators 508 and the one or more secondary operators 520 may each have a different processing time delay. As a result, a further time delay may be achieved between the processed primary sequence of data (528) and the processed secondary sequence of data (530). In some embodiments, the secondary sequence of data from the at least one secondary flow path may be time offset from the processed primary sequence of data from the primary flow path by a dynamic time offset value, and the processor may be configured to vary the dynamic time offset value. In some embodiments, the primary sequence of data may be time offset from the main sequence of data by a first time offset value and the secondary sequence of data may be time offset from the main sequence of data by a second time offset value, the first time offset value and the second time offset value defining the time offset between the primary sequence of data and the secondary sequence of data.

In some embodiments, the processor may cause the one or more primary operators to write the processed primary sequence of data (528) to the memory 2. In some embodiments, the processor may cause the one or more secondary operators 520 to write the processed secondary sequence of data (530) to the memory 4. In some embodiments, the processed secondary sequence of data (530) may be more delayed from the processed primary sequence of data (528), as described above, through reading the processed secondary sequence of data (530) and the processed primary sequence of data (528) from specific memory elements of the memory 4 and/or memory 2, respectively. In some embodiments, the processed primary sequence of data (528) may be more delayed from the processed primary sequence of data (528), through reading the processed secondary sequence of data (530) and the processed primary sequence of data (528) from specific memory elements of the memory 4 and/or memory 2, respectively.

Further, the processor may be configured to provide the processed primary sequence of data (528) and the processed secondary sequence of data (530) to the combining operator 512. In some embodiments, the processed primary sequence of data (528) and the processed secondary sequence of data (530) may be provided to the combining operator 512 from the memory 2 and memory 4 respectively. In some embodiments, generating the output data at the combining operator comprises generating the output data at the combining operator based on a merging operation on the at least one sequence of data from the processed primary sequence of data and the at least one sequence of data from the secondary sequence of data. As described above, the combining operator may be, for instance, a concatenation operator, a multiplication operator, an addition operator, a convolution operator, an integration operator, an autoregressive operator, or any other combining operator that may be configured to read at least more than one discretized spatiotemporal time series data value from the one or more memory elements of one or more memories. The combining operator as detailed above may further be configured to process the data in the memory elements and generate one or more discretized time series data value(s) at the one or more output(s) associated with the combining operator.

The processor may be configured to receive the processed primary sequence of data (528) and the processed secondary sequence of data (530) at the combining operator 512. The combining operator 512 may process at least one sequence of data from both the processed primary sequence of data (528) and processed secondary sequences of data, and time offset may be realized at the combining operator 512 based on the processing of the processed primary sequence of data (528) and the processed secondary sequence of data (530). In some embodiments, the processor may provide the output data 532 to the memory 3. In some embodiments, at least one of the one or more primary operator and the combining operator comprises a plurality of neural network layers configured to process the data.

In some embodiments, the main sequence of data 522 may be provided to the memory 1 from another combining operator in the neural network. Referring to FIG. 8B, an exemplary representation of a flow of a sequence of data in an operator-memory configuration within a neural network, in accordance with another embodiment of the disclosure. The configuration depicted in FIG. 8B is similar to the configuration depicted in FIG. 7A, and additionally, a combining operator 512′ may be provided that is configured to generate the main sequence of data 522 to be provided to the memory 1. As depicted in FIG. 8B, the combining operator 512′ may process the output data 532 that is generated by the combining operator 512, in that, the neural network may comprise a feedback path 540 over which the output data 532 may be provided to the combining operator 512′. The combining operator 512′ may process the output data 532 along with additional data, such as, from a different memory within the neural network, so as to generate the main sequence of data 522 that is provided to the memory 1.

In some embodiments, the feedback path 540 may comprise additional secondary operators configured to process the output data 532 being provided to the combining operator 512′. Referring to FIG. 8C, which illustrates a similar configuration depicted in FIG. 8B, and comprising additional secondary operators 520′ at the feedback path 540. The additional secondary operators 520′ may be configured to process the output data 532 and generate a processed output data 532′. The processed output data 532′ may be written to memory 5, and further, the processed output data 532′ may be provided to the combining operator 512′. The combining operator 512′ may process the output data 532 along with additional data, such as, from a different memory within the neural network, so as to generate the main sequence of data 522 that is provided to the memory 1. It is appreciated that the details provided above with respect to processing of data in FIG. 7A is analogously applicable to FIGS. 8B and 8C as well.

In some embodiments, the processor may be configured to provide a plurality of secondary flow paths from the memory 1, each having corresponding one or more secondary operators. Reference is made to FIG. 7B which illustrates an exemplary representation of a flow of a sequence of data in an operator-memory configuration within a neural network, in accordance with another embodiment of the disclosure. As seen in FIG. 7B, the at least one secondary flow path 506 may comprise two or more secondary flow paths 506A, . . . 506M, each having a respective secondary sequence of data, such as, secondary sequence of data (526-1), . . . secondary sequence of data (526-M). Further, each of the two or more secondary flow paths comprises respectively one or more secondary operators 520, such as, one or more secondary operators 1, to secondary operators M. It is appreciated that ‘M’ may be a real number greater than 1.

In some embodiments, at least two of the plurality of secondary flow paths comprises respective one or more secondary operators. In some embodiments, the processor may be configured to process, at the respective one or more secondary operators, at least one common sequence of data from the main sequence of data (522). That is, the processor may be configured to generate the processed secondary sequence of data (530) by processing at least one sequence of data from the main sequence of data (522).

In some embodiments, each of the two or more secondary flow paths 506 may be provided from a different memory element of the memory 1 and each one of the respective secondary sequences of data may be delayed from each other by a respective time offset value. Further, each of the one or more secondary operators may process the corresponding secondary sequence of data in order to generate corresponding processed secondary sequence of data (530-1, . . . 530-M), which may further be written to the corresponding memory, for instance, memory 4-1, memory 4-2, . . . memory 4-M. In some embodiments, each of the one or more secondary operators have a different processing time delay. As a result, time offsets may be achieved at the combining operator 512 based on the processing of the multiple processed secondary sequence of data (530) and the processed primary sequence of data (528).

In some embodiments, the processed secondary sequence of data (530) may be delayed from the processed primary sequence of data (528) by a dynamic time offset value. In some embodiments, additional memory may be provided upstream and/or downstream the one or more secondary operators 520 in order to obtain the dynamic time offset value. In some embodiments, the primary flow path 504 and the at least one secondary flow path 506 may be associated with a shared memory buffer. For instance, in some embodiments, the processor may be configured to provide the primary flow path 504 and the at least one secondary flow path 506 from a shared memory buffer, such as, memory 1.

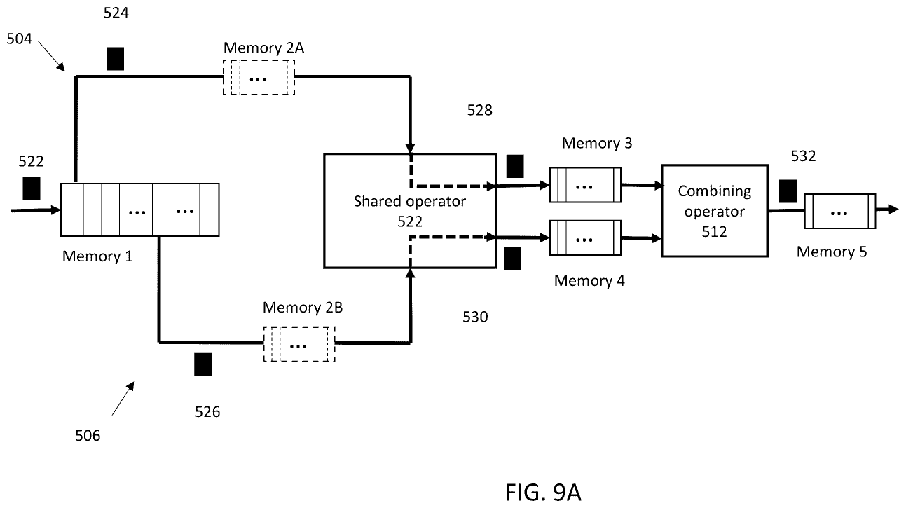

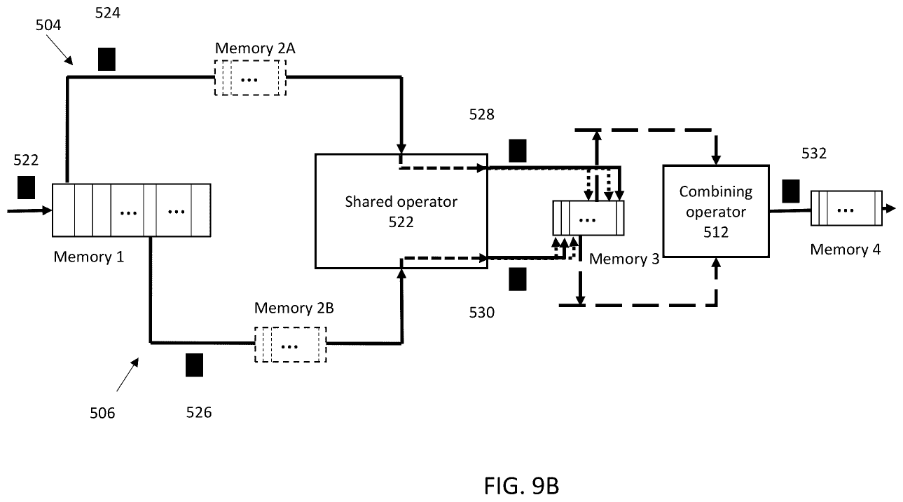

In some embodiments, the one or more primary operator 508 and the one or more secondary operators 520 may be a shared operator, in that, the processor may be configured to receive the primary sequence of data (524) and the secondary sequence of data (526) to the shared operator from the primary flow path 504 and the at least one secondary flow path respectively. The shared operator may further be configured to process the primary sequence of data (524) and the secondary sequence of data (526) in order to generate the processed primary sequence of data (528) and the processed secondary sequence of data (530). Referring to FIG. 9A, the processor may be configured to provide the primary flow path 504 and the at least one secondary flow path 506 from the memory 1. The processor may be configured to provide the primary sequence of data (524) and the secondary sequence of data (526) to the shared operator 522. In some embodiments, the primary flow path 504 may comprise a buffer memory 2A and the at least one secondary flow path 506 may comprise a buffer memory 2B configured to store the primary sequence of data (524) and the secondary sequence of data (526) respectively. The processor may be configured to provide the primary sequence of data (524) and the secondary sequence of data (526) from the memory 2A and memory 2B to the shared operator 522. The processor may be configured to generate, at the shared operator 522, the processed primary sequence of data (528) and the processed secondary sequence of data (530), as depicted in FIG. 9A. In some embodiments, the buffer memory 2A and 2B may be of different sizes. In some embodiments, the buffer memory 2A and 2B may be written and read from different memory elements of the respective buffer memory 2A and 2B, thereby adding delays between the processed primary sequence of data (528) and the processed secondary sequence of data (530). Further, the processed primary sequence of data (528) and the processed secondary sequence of data (530) may be written to a corresponding memory, such as, memory 3 and memory 4. Furthermore, the processor may be configured to provide, at the combining operator 512, the processed primary sequence of data (528) and the processed secondary sequence of data (530), and the output data may be generated at the combining operator 512 based on the processing of the processed primary sequence of data (528) and the processed secondary sequence of data (530). In some embodiments, the output data may be written to the memory 5.

In some embodiments, the processor may be configured to provide the processed primary sequence of data (528) and the processed secondary sequence of data (530), from the shared operator 522, to a common memory. Referring to FIG. 9B, the shared operator may be associated with a common memory, such as memory 3. The processor may be configured to write the processed primary sequence of data (528) and the processed secondary sequence of data (530) to the memory 3. In some embodiments, a time offset between the processed primary sequence of data (528) and the processed secondary sequence of data (530) may be achieved by using the buffer memory 2A and 2B of different sizes and/or by writing and reading from different memory elements of the respective buffer memory 2A and 2B. In some embodiments, the processed primary sequence of data (528) and the processed secondary sequence of data (530) may be written to different memory elements of the memory 3, thereby obtaining a further time offset between the processed primary sequence of data (528) and the processed secondary sequence of data (530). In some embodiments, the processed primary sequence of data (528) and the processed secondary sequence of data (530) may be provided to the combining operator 512 from different memory elements of the memory 3, thereby obtaining a further time offset, as depicted in FIG. 9B. Furthermore, the output data may be generated at the combining operator 512 based on the processing of the processed primary sequence of data (528) and the processed secondary sequence of data (530). In some embodiments, the output data may be written to the memory 4.

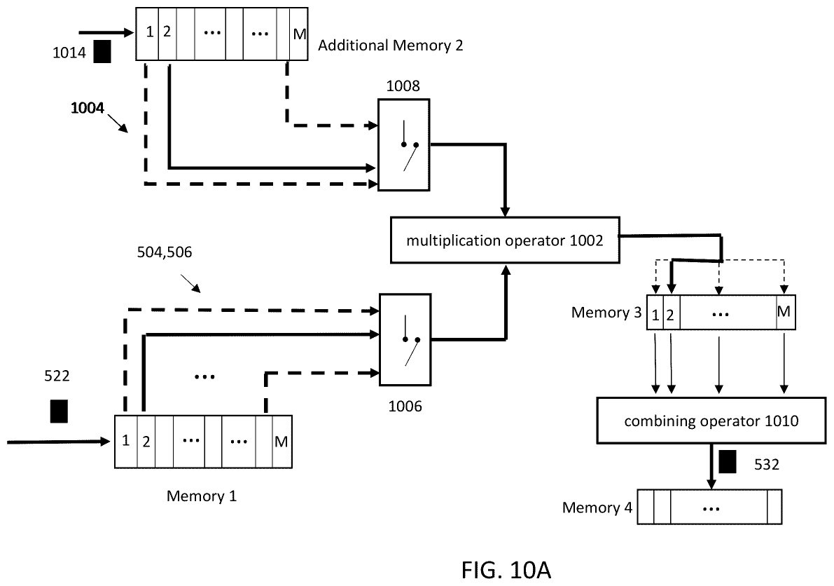

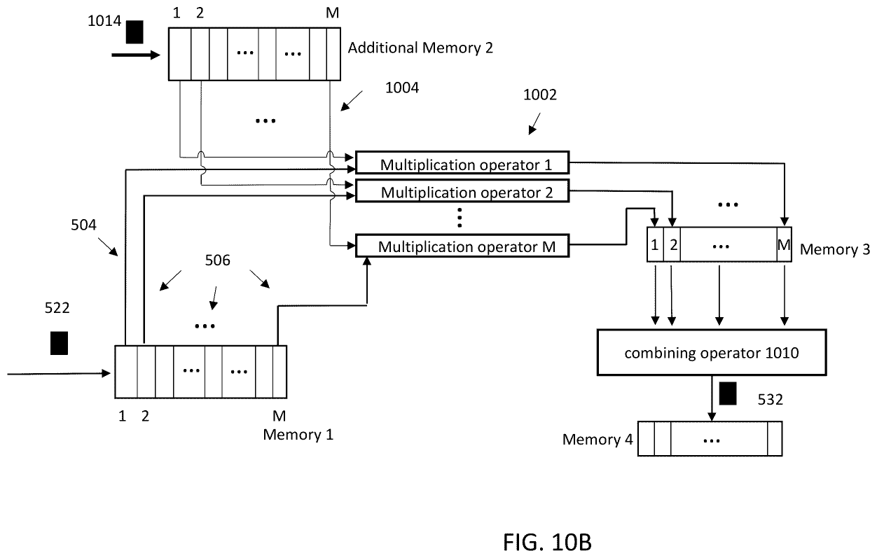

In some embodiments, the system 100 may comprise an additional memory associated with one or more of the memories of one or more of the sequence(s) from the main sequence of data (522), the additional memory comprising additional values stored therein. In some embodiments, the additional memory may be a kernel memory storing kernel values, one kernel value being stored in each memory element for the length of the additional memory, being the length of the kernel. In some embodiments, a temporal kernel may be represented where a kernel value for each timestep is encoded in each of the memory elements. In such an embodiment, correspondingly, the memory 1 stores a temporal data sequence in each of the memory elements for each of the timestep, and thus, the additional memory may be referred to as a sequential memory. Referring to FIG. 10A, a memory-operator configuration is depicted in accordance with an embodiment of the disclosure. As seen in FIG. 10A, the processor may be configured to provide a main sequence of data (522) to memory 1. The processor may further be configured to provide, to a multiplication operator 1002, flow paths 504, 506 from memory 1. In some embodiments, the multiplication operator 1002 is a shared operator, in that, the multiplication operator 1002 is used in series relative to each of the memory elements (1 to M) of memory 1 and the additional memory 2.

Further, the processor may be configured to provide, to the multiplication operator 1002, additional flow paths 1004 from the additional memory, i.e., memory 2. In some embodiments, the processor may further be configured to provide additional input 1014 to the additional memory 2, the additional input 1014 being associated with an update in the kernel values stored in the additional memory 2. For instance, the kernel values stored in the additional memory 2 may be updated or changed during learning. The processor is further configured to receive serially, that is one value at a time, at the multiplication operator 1002, a first value from the data sequence from memory 1 and a first value from the additional memory 2. Further, the first value from the data sequence from memory 1 and the first value from the additional memory 2 is processed, i.e., multiplied at the multiplication operator 1002, and the output from the multiplication operator 1002 is stored at a first memory element of the memory 3. Further, sequentially, a second value from the data sequence from memory 1 and a second value from the additional memory 2 may be received at the multiplication operator 1002, multiplied to obtain output, and the output may then be stored in the second memory element of the memory 3. The above noted process may be repeated for a third value from the data sequence, a fourth value from the data sequence, and so on, until the last element of the memory 1 and/or the additional memory 2 is reached.

As depicted in FIG. 10A, a first switch 1006 may be associated with the data sequence to select one memory element value at a time. Further, a second switch 1008 may be associated with the additional flow paths in order to select one memory element at a time.

The processor may further be configured to receive the processed primary sequence of data and the processed secondary sequence of data (530) at a combining operator 1010. In some embodiments, the combining operator 1010 may be a summation operator, summing over all memory elements (1 to M) of the memory 3. In some embodiments, the summation operator may sum all memory 3 cells simultaneously. In some embodiments, the summation may be performed through prefix sums. The processor may be configured to generate, at the combining operator 1010, a temporally convoluted output data based on the processing of the processed primary sequence of data (528) and the processed secondary sequence of data (530) at the combining operator 1010. The processor may further be configured to store the temporally convoluted output data at the memory 4.

As one or multiple new values arrive in the main sequence of data (522), the process above may be repeated to evaluate a temporal convolution at the desired interval of arriving new values.

Though the above description relates to temporal kernel, it is appreciated that in some embodiments, the additional memory 2 may be a kernel memory storing kernel values, in that, a spatial kernel may be represented where a kernel value for each bin of the spatial dimension is encoded in each of the memory element of the additional memory 2. In such an embodiment, correspondingly, the memory 1 stores a spatial data sequence in each of the memory cell for each of the spatial bin. It is further appreciated that the details provided above with respect to FIG. 10A is applicable when using the spatial kernel.

In some embodiments, the processor may be configured to provide the primary sequence of data (524) and the secondary sequence of data (526) at corresponding multiplication operators parallelly. Referring to FIG. 10B, each of the primary flow path, the at least one secondary flow path, and the additional flow paths may be associated with a corresponding multiplication operator 1002, such as, multiplication operator 1, multiplication operator 2, . . . multiplication operator M. The processor may be configured to provide the main sequence of data 522 to the memory 1. In some embodiments, the processor may further be configured to provide additional input 1014 to the additional memory 2, the additional input 1014 being associated with an update in the kernel values stored in the additional memory 2. For instance, the kernel values stored in the additional memory 2 may be updated or changed during learning. The processor may be configured to provide the primary sequence of data (524) from the memory 1 and the corresponding additional values from the memory 2 to the associated multiplication operator. Further, the processor may be configured to provide the secondary sequence of data (526) from the memory 1 and the corresponding additional values from the memory 2 to the associated multiplication operator. It is appreciated that the details provided above with respect to processing of data by the multiplication operator in FIG. 10A is analogously applicable to FIG. 10B as well.

The processor may be configured to generate the processed primary sequence of data (528) and the processed secondary sequence of data (530) at the corresponding multiplication operators, and write the processed primary sequence of data (528) and the processed secondary sequence of data (530) to the memory 3. The processor may further be configured to receive, at the combining operator 1010, the processed primary sequence of data (528) and the processed secondary sequence of data (530). In some embodiments, the combining operator may be a summation operator. The summation operator may sum all memory 3 cells simultaneously. In some embodiments, the summation may be performed through prefix sums. The processor may be configured to generate, at the combining operator 1010, a temporally convoluted output data based on the processing of the processed sequence of data, primary and secondary, and the kernel in memory 2. The processor may further be configured to store the temporally convoluted output data at the memory 4.

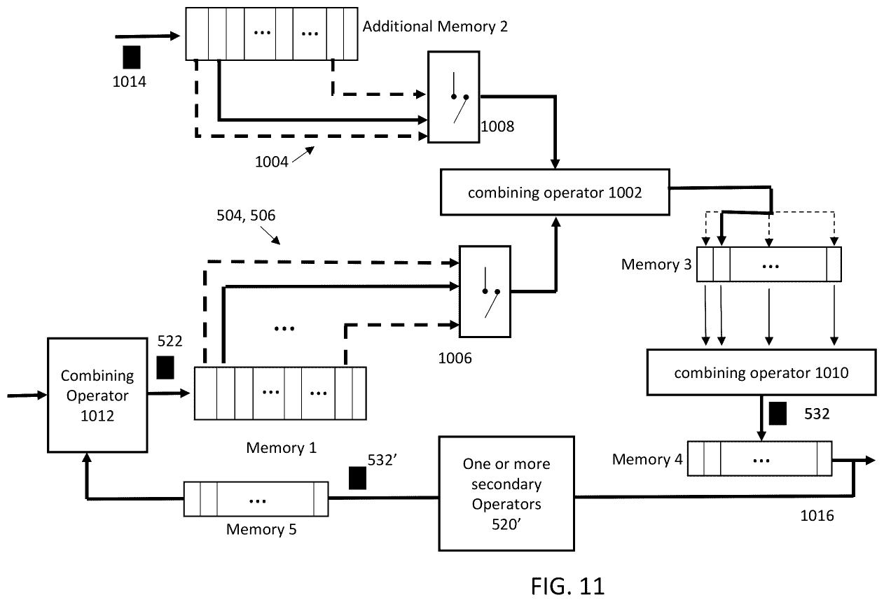

In the operator memory configurations described above with respect to FIG. 10A-10B, the memories may be used to buffer the input, i.e., the main sequence of data. In case of time-series data, the temporal convolution is achieved by a dot product of the values stored in the memory, such as memory 1 in FIGS. 10A-10B, and the kernel values, in particular, temporal kernel values, stored in the additional memory. The operation of the memories and the flow of the sequences of data is representative of a sliding window mechanism that is generally needed for performing convolution operations. The memories may thus be beneficial while performing temporal convolutions. In some embodiments, a feedback path may be provided to feed back the output data 532 generated at the combining operator 1010 to another combining operator within the neural network. Referring to FIG. 11, an operator-memory configuration is illustrated which is similar to the configuration depicted in FIG. 10A with the addition of a feedback path 1016 and one or more secondary operators 520′ on the feedback path 1016. As seen in FIG. 11, the output data 532 is read from the memory 4 and fed back to the combining operator 522. The output data may be processed by the one or more secondary operators 520′ to generate a processed output data 532′. The processed output data 532′ may be read from the memory 5 and provided to the combining operator 1012. The combining operator 1012 may thus generate the main sequence of data 522 based on the processing of the processed output data 532′ received over the feedback path 1016 with one or more other data sequences received from other operator-memory combinations within the neural network. It is appreciated that the details provided above with respect to processing of data in FIG. 10A is analogously applicable to FIG. 11 as well and the same is not repeated for sake of brevity.

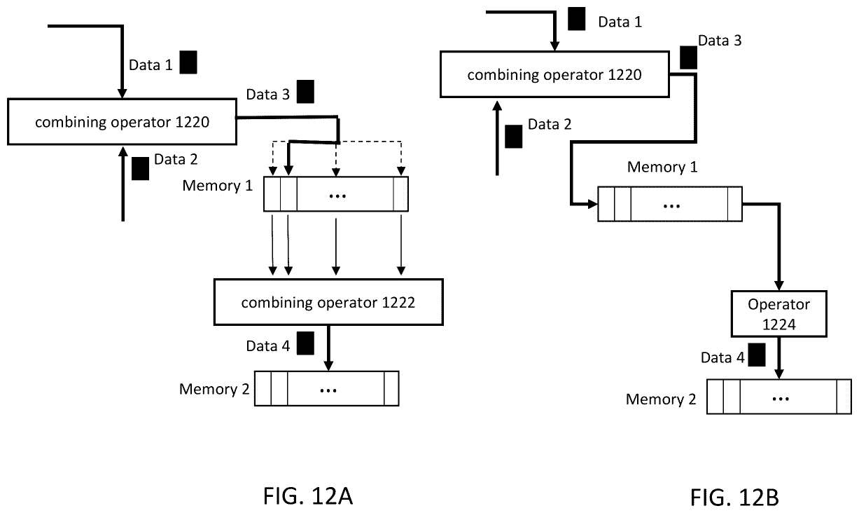

In addition to the use of the memories for performing convolutions, the memories may be utilized for adding and/or increasing delays in data sequences and keeping the data sequences unsynchronized. Accordingly, a dual purpose is achieved for the memories, in that, the memories may be used to facilitate convolution as well as facilitate generation of time delays between different data sequences. Referring to FIGS. 12A and 12B, operator-memory configurations are depicted for use of memory as storage for parallel operation, and use of memory as a delay buffer memory, respectively. In FIG. 12A, similar to the data processing performed with reference to FIG. 10A, the combining operator 1220 processes data 1 and data 2, in which, data 1 may comprise temporal kernel values while data 2 may comprise data sequences. For instance, data 1 and data 2 may be received serially at the combining operator 1220, and further, a first value of data 1 may be processed with a first value of data 2 in order to generate data 3 at the combining operator 1220. In some embodiments, the combining operator 1220 may be a multiplication operator. The data 3 generated at the combining operator 1220 may be stored in memory 1. Further, from memory 1, data may be parallelly read and provided to another combining operator 1222, which processes the parallelly received data from memory 1 and generates data 4 to be stored in the memory 4. Accordingly, in the operator-memory configuration of FIG. 12A, the memory 1 may facilitate temporal convolution.

Further, in case temporal convolution is not being performed, such as in FIG. 12B, where the combining operator 1220 processes different data sequences data 1 and data 2, the memory 1 may be used to add or increase delay to the data sequences. For instance, the combining operator 1220 may process data 1 and data 2 to generate data 3 at the combining operator 1220. Further, the data 3 may be written to a specific memory element of memory 1, and read from a specific memory element of memory 1 when the data 3 is to be provided to another operator 1224 within the neural network. The memory 1 may thus be utilized to delay the arrival of the data 3 at the operator 1224 based on the reading time instances of the data 3 from the memory 1. Once the data 3 with added delay is provided to the operator 1224, the operator 1224 may process the data 3 and generate data 4 to be stored in memory 2. The operator-memory configurations as depicted in FIGS. 12A-12B thus essentially eliminates the use of extra buffer memories, i.e., use of separate memories for convolution operations and for time delay purposes. A dual-purpose is being achieved leading to memory-efficient configurations of neural networks. In some embodiments, the memories in the neural network may be utilized simultaneously for both adding time delays as well as performing temporal convolution. The dual purposing of memories improves the computation efficiency of the network, and allows for effective implementations neural networks for edge devices.

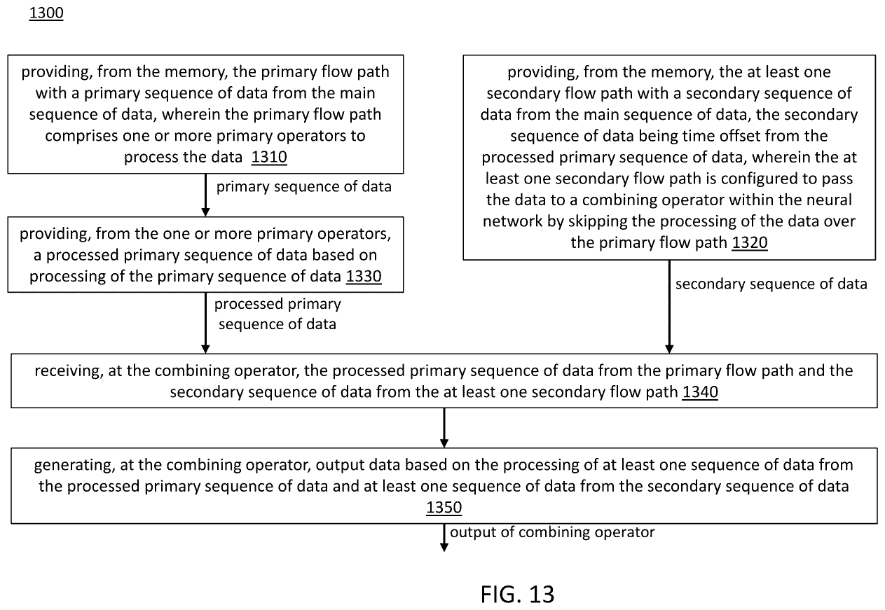

FIG. 13 illustrates a flow chart of a method 1300 for processing data in a neural network, in accordance with an embodiment of the present disclosure. The method 1300 may be performed by the system 200 comprising the processor 201 and a memory having a plurality of memory elements associated with a primary flow path and at least one secondary flow path within the neural network. The data may comprise a main sequence of data and the processor 201 may be configured to control and perform the operations of method 1300 in conjunction with various operators and associated memories, as described above.

At step 1310, the method comprises providing, from the memory, the primary flow path with a primary sequence of data from the main sequence of data. The primary flow path may comprise one or more primary operators to process the data.

At step 1320, the method comprises providing, from the memory, the at least one secondary flow path with a secondary sequence of data from the main sequence of data. The secondary sequence of data may be time offset from the processed primary sequence of data. Further, the at least one secondary flow path may be configured to pass the data to a combining operator within the neural network by skipping the processing of the data over the primary flow path. It is appreciated that the steps 1310 and 1320 may be performed simultaneously.

At step 1330, the method comprises providing, from the one or more primary operators, a processed primary sequence of data based on processing of the primary sequence of data.

At step 1340, the method comprises receiving, at the combining operator, the processed primary sequence of data from the primary flow path and the secondary sequence of data from the at least one secondary flow path.

At step 1350, the method comprises generating, at the combining operator, output data based on the processing of at least one sequence of data from the processed primary sequence of data and at least one sequence of data from the secondary sequence of data.

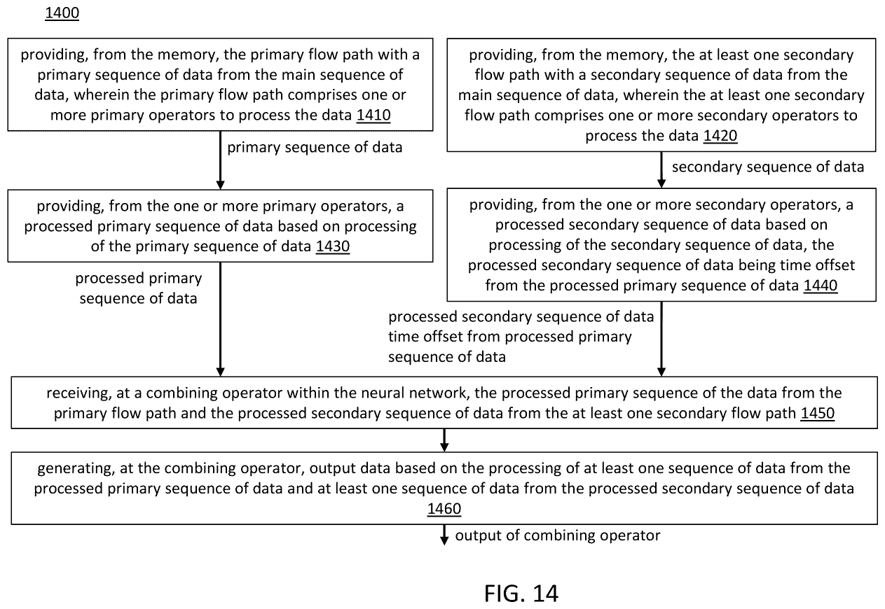

FIG. 14 illustrates a flow chart of a method 1400 for processing data in a neural network, in accordance with an embodiment of the present disclosure. The method 1400 may be performed by the system 200 comprising the processor 201 and a memory having a plurality of memory elements associated with a primary flow path and at least one secondary flow path within the neural network. The data may comprise a main sequence of data and the processor 201 may be configured to control and perform the operations of method 1400 in conjunction with various operators and associated memories, as described above.

At step 1410, the method comprises providing, from the memory, the primary flow path with a primary sequence of data from the main sequence of data. The primary flow path may comprise one or more primary operators to process the data.

At step 1420, the method may comprise providing, from the memory, the at least one secondary flow path with a secondary sequence of data from the main sequence of data. The at least one secondary flow path may comprise one or more secondary operators to process the data;

At step 1430, the method comprises providing, from the one or more primary operators, a processed primary sequence of data based on processing of the primary sequence of data.

At step 1440, the method comprises providing, from the one or more secondary operators, a processed secondary sequence of data based on processing of the secondary sequence of data, the processed secondary sequence of data being time offset from the processed primary sequence of data.

At step 1450, the method comprises receiving, at a combining operator within the neural network, the processed primary sequence of the data from the primary flow path and the processed secondary sequence of data from the at least one secondary flow path.

At step 1460, the method comprises generating, at the combining operator, output data based on the processing of at least one sequence of data from the processed primary sequence of data and at least one sequence of data from the processed secondary sequence of data.

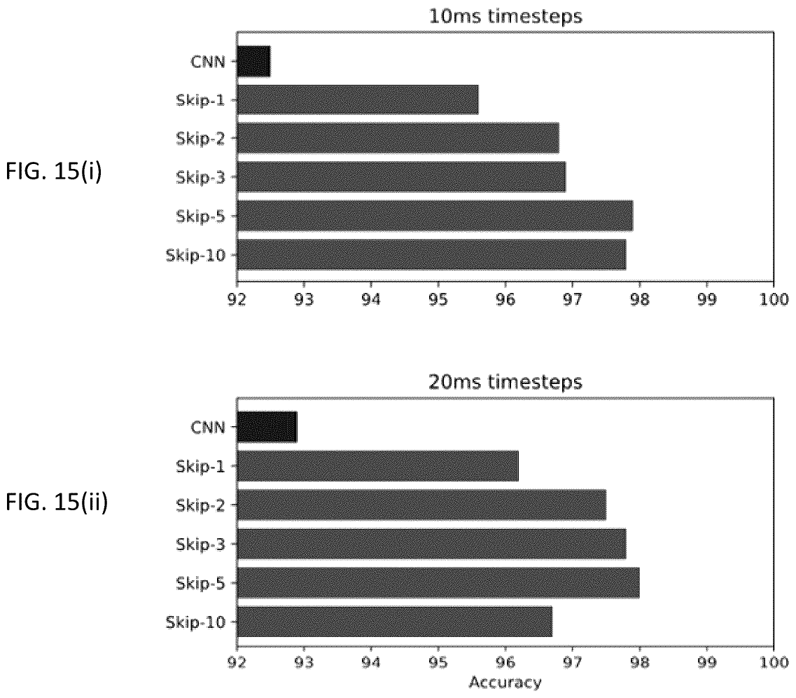

FIG. 15(i) and FIG. 15(ii) showcase bar graphs illustrating improved accuracy results attained through the implementation of some of the various embodiments of the proposed invention. These results are of different network model implementation variants on the DVS128 dataset. These results were anticipated by the inventors, and verified through network training, forming the basis of the proposed invention.

The dataset is the DVS128 hand gesture recognition dataset, where the events are binned into event frames. The inventors tried time bins of 10 ms and 20 ms for the experimentation. The frames are fed sequentially to the network (or streamed) for evaluation.

For the backbone network, the inventors stacked 5 inverted residual blocks (from MobileNet v2) together. The baseline CNN model of FIG. 15 uses synchronization of the main and skip paths for each residual block, meaning that there is no temporal delay or advancement in the skip path. A skip-n indicates a temporal advancement of n steps in the skip path.

Since the main path of each residual block contains 3 convolution operators, each taking one timestep, for synchronization in the baseline CNN, one would require a memory buffer (such as a FIFO buffer) of depth 3 in the skip path. For skip-n, where n<3, one would require a buffer of depth 3-n in the skip path. For skip-n, where n>3, one would require a buffer of depth n−3 in the main path. Therefore, it should be noted that for all scenarios when n is not equal to 3, a memory buffer would be required, whereas when n is equal to 3, no memory buffer is required.

The prior art employs a skip-0 network (the CNN in FIG. 15), synchronizing inputs at a merging point (see FIG. 1) by utilizing a memory buffer in the skip path.

The proposed invention on the other hand improves accuracy when contrasted with skip-0 network as known in the art that implements “zero” time offset at a merging point; that is adopts synchronization in other wordings. It should be appreciated that the skip-3 network operates without needing a memory buffer for synchronization in both the main and skip paths, resulting in lower memory requirements compared to the baseline, while still delivering superior performance. In other words, comparing the proposed skip-3 network to the prior art's skip-0 network reveals enhanced accuracy and the advantageous absence of the memory buffer in the skip path. This advantageously makes the proposed invention suitable for edge applications as it improves accuracy while requiring less memory when implemented on chip.

On the other hand, skip-1, skip-2, skip-5 and skip-10 networks require memory buffer in skip path or main path, to implement time offset at a merging point, however, provides better accuracy results. In particular, skip-5 and skip 10 were noted to provide better accuracy results when compared to skip-3 (FIG. 15(i)). A person skilled in the art would appreciate that skip-n in various networks (whereas n is not equal to 0) could be implemented based on the achieved accuracy result and available memory.

To understand the amount of effective advancement (time offset), consider a skip-5 network, with timestep of 10 ms bin. For each residual block, it would require a buffer of depth 5−3=2 in the main path to achieve an advancement of 5 timesteps in the skip path, corresponding to 5*10 ms=50 ms of advancement. Since each residual block introduces a temporal advancement, 6 residual blocks, say, in such a model would achieve a total effective advancement, by the end of the 6th block, of 6×50 ms=300 ms.

The present disclosure provides methods and systems for neural networks that process continuous input data in parallel pathways by time delaying the continuous input being received over the parallel pathways, i.e., without the synchronization of continuous input data. In conventional data processing methods and systems, data is processed in a synchronized manner. In fact, in conventional methods and systems, the neural networks are configured so as to purposely achieve synchronization of data to be processed. This may be done, for instance, by providing memory buffers in the parallel paths. However, neural networks generally comprise multiple layers and multiple skip connections, and as a result, achieving synchronization of parallel pathways over the multiple layers and connections is a complicated task. For example, extensive memory buffers may need to be provided to achieve synchronization.

A main aspect of the present disclosure is that for sequential data, the neural network does benefit from generating pathways with different time offsets (delays) in order to facilitate the creation of a dynamical system embedding of the sequential data within the network. The dynamical system embedding permits the representation, for example, of dynamical attractors within the network, which provides for a richer and more accurate representation of the sequential data, leading to better predictions in short-term, mid-term, and long-term. The fact that the neural network performance improved by skipping the synchronization and adding time offsets in a skipNN processing sequential data may be grasped by a dynamical system theory perspective.

In the present disclosure, accurate and efficient processing of data is achieved without the need for synchronizing continuous data being received over parallel pathways. Data sequences may be provided to various operators, such as combining operators, in the neural network, the operators being configured to process the sequence of data that is not received in a synchronized manner.

The data may be received without synchronization, i.e., with time delays, at the combining operators for processing over different paths. The combining operator may process the asynchronized data and a time offset may be realized at the combining operator. For instance, in FIG. 5A-5C, primary sequence of data may be delayed due to processing time of the one or more primary operators 508 on the primary flow path 504. The secondary sequence of data 526 may be provided unprocessed to the combining operator 512. Moreover, delays may be added/reduced based on reading of the data sequences from the memory 1. A time offset is realized at the combining operator 512 as the combining operator processes the data sequences received over the primary flow path and the secondary flow path. Further, buffer memories to achieve synchronization of data sequences is not necessary. Accordingly, there are no constraints on implementation of large neural network with skip connections as was the case with conventional methods and systems where buffer memories were required for synchronization.

Further, the delays may be adjusted up to certain maximums, as discussed throughout the present disclosure. For instance, the delays may be associated with processing time of the operators on the primary flow path 504. Additionally, as seen in FIGS. 7A-7B, one or more secondary operators 520 may be provided on the secondary flow path 506, in addition to the one or more primary operators 508 provided on the primary flow path 504. The combining operator 512 thus processes the processed primary sequence of data and the processed secondary sequence of data that are at time offset.

The disclosure identifies that multiple time-offsets may be used and that optimization on the time-offsets parameters or selection over some time-offset values may be used to improve performance. Hence, during training, an iterative process with error feedback may be used to unravel time offset values in the multitude of pathways to improve or optimize the network performance. Another approach may be during training to generate a multitude of time offsets and then by pruning or selection according to some performance criteria keep a set of the best performing time-offsets.

Further, memories may be utilized in the convoluted layer pathway or the skip pathway specifically in order to introduce and/or increase the delay. As seen in FIGS. 6A-6B, buffer memories (memory 4) may be provided on the primary flow path 504 and/or the secondary flow path 506. The data sequences to be provided to the combining operator 512 may thus be delayed further based on the reading times from the buffer memories. Moreover, the sequences of data that is received at the memory 1 may be modified based on the output data of the combining operator 512. That is, in some cases as seen in FIGS. 8A-8C, feedback paths may be provided and the output data from the combining operator may be fed back to generate the main sequence of data through another combining operator in the neural network. Additionally, the memories may be used for a dual purpose, as depicted with reference to FIGS. 10A-10B and 12A-12B. In particular, the memories may be used for adding and/or increasing delays in data sequences as well as for facilitating temporal convolutions. Accordingly, systems and methods described herein allow processing of data by neural network based on a memory-efficient configuration.

The methods, systems, and devices discussed above are examples. Various configurations may omit, substitute, or add various procedures or components as appropriate. For instance, in alternative configurations, the methods may be performed in an order different from that described, and various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur in a different order than shown in any flowchart. For example, two blocks shown in succession may be executed substantially concurrently or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of three of the five blocks may be performed and/or executed.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having been provided with the description and illustration of the present application, one skilled in the art may envision variations, modifications, and alternate embodiments falling within the general inventive concept discussed in this application that does not depart from the scope of the following claims.

1. A system comprising:
a processor configured to process data in a neural network, the data comprising a main sequence of data;
a memory comprising a plurality of memory elements associated with a primary flow path and at least one secondary flow path within the neural network, wherein the primary flow path comprises one or more primary operators to process the data, and wherein the at least one secondary flow path is configured to pass the data to a combining operator within the neural network by skipping the processing of the data over the primary flow path,
wherein the processor is configured to:
provide, from the memory, the primary flow path with a primary sequence of data from the main sequence of data;
provide, from the one or more primary operators, a processed primary sequence of data based on processing of the primary sequence of data;
provide, from the memory, the at least one secondary flow path with a secondary sequence of data from the main sequence of data, the secondary sequence of data being time offset from the processed primary sequence of data;
receive, at the combining operator, the processed primary sequence of data from the primary flow path and the secondary sequence of data from the at least one secondary flow path; and
generate, at the combining operator, output data based on the processing of at least one sequence of data from the processed primary sequence of data and at least one sequence of data from the secondary sequence of data.

2. The system of claim 1, wherein the at least one secondary flow path is devoid of a memory buffer, wherein the memory buffer would eliminate the time offset between the processed primary sequence of data and the secondary sequence of data.

3. The system of claim 1, wherein the at least one secondary flow path comprises two or more secondary flow paths, and
wherein the processor is further configured to provide, from the memory, the two or more secondary flow paths each having a respective secondary sequence of data, each one of the respective secondary sequence of data being time offset from each other by a respective time offset value.

4. The system of claim 3, wherein the processor is further configured to:
provide a first one of the two or more secondary flow paths from a memory element of the plurality of memory elements, and
provide a second one of the two or more secondary flow paths from a different memory element of the plurality of memory elements.

5. A method for processing data in a neural network, the data comprising a main sequence of data, the method being performed by a system comprising a processor and a memory having a plurality of memory elements associated with a primary flow path and at least one secondary flow path within the neural network, the method comprising:
providing, from the memory, the primary flow path with a primary sequence of data from the main sequence of data, wherein the primary flow path comprises one or more primary operators to process the data;
providing, from the one or more primary operators, a processed primary sequence of data based on processing of the primary sequence of data;
providing, from the memory, the at least one secondary flow path with a secondary sequence of data from the main sequence of data, the secondary sequence of data being time offset from the processed primary sequence of data, wherein the at least one secondary flow path is configured to pass the data to a combining operator within the neural network by skipping the processing of the data over the primary flow path;
receiving, at the combining operator, the processed primary sequence of data from the primary flow path and the secondary sequence of data from the at least one secondary flow path; and
generating, at the combining operator, output data based on the processing of at least one sequence of data from the processed primary sequence of data and at least one sequence of data from the secondary sequence of data.

6. The method of claim 5, wherein the at least one secondary flow path is devoid of a memory buffer, wherein the memory buffer would eliminate the time offset between the processed primary sequence of data and the secondary sequence of data.

7. The method of claim 5, wherein the at least one secondary flow path comprises two or more secondary flow paths, and
the method further comprises providing, from the memory, the two or more secondary flow paths each having a respective secondary sequence of data, each one of the respective secondary sequence of data being time offset from each other by a respective time offset value.

8. The method of claim 7, further comprising:
providing a first one of the two or more secondary flow paths from a memory element of the plurality of memory elements, and
providing a second one of the two or more secondary flow paths from a different memory element of the plurality of memory elements.

9. A system comprising:
a processor configured to process data in a neural network, the data comprising a main sequence of data;
a memory comprising a plurality of memory elements associated with a primary flow path and at least one secondary flow path within the neural network, wherein the primary flow path comprises one or more primary operators to process the data, and wherein the at least one secondary flow path comprises one or more secondary operators to process the data;
wherein the processor is configured to:
provide, from the memory, the primary flow path with a primary sequence of data from the main sequence of data;
provide, from the memory, the at least one secondary flow path with a secondary sequence of data from the main sequence of data;
provide, from the one or more primary operators, a processed primary sequence of data based on processing of the primary sequence of data; and
provide, from the one or more secondary operators, a processed secondary sequence of data based on processing of the secondary sequence of data, the processed secondary sequence of data being time offset from the processed primary sequence of data;
receive, at a combining operator within the neural network, the processed primary sequence of the data from the primary flow path and the processed secondary sequence of data from the at least one secondary flow path; and
generate, at the combining operator, output data based on the processing of at least one sequence of data from the processed primary sequence of data and at least one sequence of data from the processed secondary sequence of data.

10. The system of claim 9, wherein the at least one secondary flow path is devoid of a memory buffer, wherein the memory buffer would eliminate the time offset between the processed primary sequence of data and the secondary sequence of data.

11. The system of claim 9, wherein the system includes an additional memory associated with the primary flow path and the at least one secondary flow path within the neural network, and
wherein to provide the processed primary sequence of data and the processed secondary sequence of data, the processor is configured to:
provide from the one or more primary operators, the processed primary sequence of data by processing the primary sequence of data stored in the memory and corresponding additional values stored in the additional memory; and
provide from the one or more secondary operators, the processed secondary sequence of data by processing the secondary sequence of data stored in the memory and the corresponding additional values stored in the additional memory.

12. The system of claim 11, wherein each of the one or more primary operators and the one or more secondary operators comprises a multiplication operator,
wherein the corresponding additional values stored in the additional memory comprises corresponding kernel values,
wherein the combining operator is a summation operator, and
wherein the processor is further configured to:
receive, at the summation operator, the processed primary sequence of data and the processed secondary sequence of data from the respective multiplication operators, and
generate, at the summation operator, a temporally convoluted output data based on the processing of the processed primary sequence of data and the processed secondary sequence of data.

13. The system of claim 12, wherein the processor is configured to:
parallelly provide, at the respective multiplication operators, the primary sequence of data and the corresponding kernel values, and the secondary sequence of data and the corresponding kernel values.

14. The system of claim 12, wherein the processor is configured to:
serially provide, at the respective multiplication operators, the primary sequence of data and the corresponding kernel values, and the secondary sequence of data and the corresponding kernel values.

15. The system of claim 9, wherein at least one of the one or more primary operators and at least one of the one or more secondary operators is a shared operator, and wherein the processor is further configured to:
receive, at the shared operator, the primary sequence of data from the primary flow path and the secondary sequence of data from the at least one secondary flow path, and
provide, from the shared operator, the processed primary sequence of the data and the processed secondary sequence of data.

16. The system of claim 9, wherein the at least one secondary flow path comprises two or more secondary flow paths, and
wherein the processor is further configured to provide, from the memory, the two or more secondary flow paths each having a respective secondary sequence of data, each one of the respective secondary sequence of data being time offset from each other by a respective time offset value.

17. The system of claim 16, wherein the processor is further configured to:
provide a first one of the two or more secondary flow paths from a memory element of the plurality of memory elements, and
provide a second one of the two or more secondary flow paths from a different memory element of the plurality of memory elements.

18. The system of claim 9, wherein one or more of the primary flow path and the at least one secondary flow path are associated with a shared memory buffer, and the processed secondary sequence of data is time offset from the processed primary sequence of data by a dynamic time offset value.

19. The system of claim 9, wherein the at least one secondary flow path comprises a plurality of secondary flow paths, wherein at least two of the plurality of secondary flow paths comprises respective one or more secondary operators, and wherein the processor is configured to generate, at the respective one or more secondary operators of the at least two of the plurality of secondary flow paths, the processed secondary sequence of data by processing of at least one common sequence of data from the main sequence of data.

20. A method for processing data in a neural network, the data comprising a main sequence of data, the method being performed by a system comprising a processor and a memory having a plurality of memory elements associated with a primary flow path and at least one secondary flow path within the neural network, the method comprising:
providing, from the memory, the primary flow path with a primary sequence of data from the main sequence of data, wherein the primary flow path comprises one or more primary operators to process the data;
providing, from the memory, the at least one secondary flow path with a secondary sequence of data from the main sequence of data, wherein the at least one secondary flow path comprises one or more secondary operators to process the data;
providing, from the one or more primary operators, a processed primary sequence of data based on processing of the primary sequence of data; and
providing, from the one or more secondary operators, a processed secondary sequence of data based on processing of the secondary sequence of data, the processed secondary sequence of data being time offset from the processed primary sequence of data;
receiving, at a combining operator within the neural network, the processed primary sequence of the data from the primary flow path and the processed secondary sequence of data from the at least one secondary flow path; and
generating, at the combining operator, output data based on the processing of at least one sequence of data from the processed primary sequence of data and at least one sequence of data from the processed secondary sequence of data.

21. The method of claim 20, wherein the at least one secondary flow path is devoid of a memory buffer, wherein the memory buffer would eliminate the time offset between the processed primary sequence of data and the secondary sequence of data.

22. The method of claim 20, wherein providing the processed primary sequence of data and the processed secondary sequence of data comprises:
providing from the one or more primary operators, the processed primary sequence of data by processing the primary sequence of data stored in the memory and corresponding additional values stored in an additional memory associated with the primary flow path and the at least one secondary flow path within the neural network; and
providing from the one or more secondary operators, the processed secondary sequence of data by processing the secondary sequence of data stored in the memory and the corresponding additional values stored in the additional memory.

23. The method of claim 22, wherein each of the one or more primary operators and the one or more secondary operators comprises a multiplication operator,
wherein the corresponding additional values stored in the additional memory comprises corresponding kernel values,
wherein the combining operator is a summation operator, and
wherein the method further comprises:
receiving, at the summation operator, the processed primary sequence of data and the processed secondary sequence of data from the respective multiplication operators, and
generating, at the summation operator, a temporally convoluted output data based on the processing of the processed primary sequence of data and the processed secondary sequence of data.

24. The method of claim 23, the method further comprising:
parallelly providing, at the respective multiplication operators, the primary sequence of data and the corresponding kernel values, and the secondary sequence of data and the corresponding kernel values.

25. The method of claim 23, the method further comprising:
serially providing, at the respective multiplication operators, the primary sequence of data and the corresponding kernel values, and the secondary sequence of data and the corresponding kernel values.

26. The method of claim 20, wherein at least one of the one or more primary operators and at least one of the one or more secondary operators is a shared operator, and wherein the method further comprises:
receiving, at the shared operator, the primary sequence of data from the primary flow path and the secondary sequence of data from the at least one secondary flow path, and
providing, from the shared operator, the processed primary sequence of the data and the processed secondary sequence of data.

27. The method of claim 20, wherein the at least one secondary flow path comprises two or more secondary flow paths, and
wherein the method further comprises providing, from the memory, the two or more secondary flow paths each having a respective secondary sequence of data, each one of the respective secondary sequence of data being time offset from each other by a respective time offset value.

28. The method of claim 27, the method further comprising:
providing a first one of the two or more secondary flow paths from a memory element of the plurality of memory elements, and
providing a second one of the two or more secondary flow paths from a different memory element of the plurality of memory elements.

29. The method of claim 20, wherein one or more of the primary flow path and the at least one secondary flow path are associated with a shared memory buffer, and the processed secondary sequence of data is time offset from the processed primary sequence of data by a dynamic time offset value.

30. The method of claim 20, wherein the at least one secondary flow path comprises a plurality of secondary flow paths, wherein at least two of the plurality of secondary flow paths comprises respective one or more secondary operators, and wherein the method comprises generating, at the respective one or more secondary operators of the at least two of the plurality of secondary flow paths, the processed secondary sequence of data by processing of at least one common sequence of data from the main sequence of data.

31. The method of claim 20, wherein the data is at least one of time-series data and non-time series data.
